(19) United States
(12) Patent Application Publication
(10) Pub. No.: US 2013/0156308 A1
(43) Pub. Date: Jun. 20, 2013

(54) PICTURE DETECTION DEVICE, PICTURE RECORDING DEVICE, PICTURE RECORDING/REPRODUCTION DEVICE, PICTURE DETECTION METHOD, PICTURE RECORDING METHOD, AND PICTURE RECORDING/REPRODUCTION METHOD

(71) Applicant: FUJITSU SEMICONDUCTOR LIMITED, Yokohama-shi (JP)

(72) Inventor: Akio ABE, Sendai (JP)

(21) Appl. No.: 13/669,678

(22) Filed: Nov. 6, 2012

(30) Foreign Application Priority Data
Dec. 20, 2011 (JP) 2011-278134

(51) Int. Cl. G06K 9/46

(52) U.S. Cl. CPC G06K 9/4652
USPC 382/165

(57) ABSTRACT

A picture detection device includes an estimation unit configured to, based on deviations in color information of pixels of a prescribed number of lines in an upper-edge portion, lower-edge portion, left-edge portion, and right-edge portion of a picture frame including a first picture and a second picture displayed on the periphery of the first picture, estimate an edge portion of the picture frame in which the second picture is displayed from among above-described four portions; and a detection unit configured to detect the first picture of the picture flame; wherein the detection unit moves a borderline detection line from the center of the picture frame toward the estimated edge portion, and detects a borderline between the first picture and the second picture based on a brightness difference of pixels in the vicinity of the borderline detection line, and detects the first picture based on the detected borderline.

### CROSS-REFERENCE TO RELATED APPLICATION

This application is based upon and claims the benefit of priority of the prior Japanese Patent Application No. 2011-278134, filed on Dec. 20, 2011, the entire contents of which are incorporated herein by reference.

### FIELD

This invention relates to a picture detection device, picture recording device, picture recording/reproduction device, picture detection method, picture recording method, and picture recording/reproduction method.

### BACKGROUND

As pictures in television broadcasts, added information can be superimposed as a telop on a main picture and displayed, or an L-shape or other boundary region can for example be formed on the periphery of a main picture, with added information displayed therein. The picture displayed in the L-shape region is called a subpicture.

FIG. 1 schematically illustrates an example of a picture in which are displayed such a main picture and subpicture. The picture frame PF has a main picture MN and a subpicture SB. The vertical-direction borderline between the main picture MN and the subpicture SB is indicated by the symbol VBL1, and the horizontal-direction borderline is indicated by the symbol HBL1.

In the center of the main picture MN is displayed, for example, an interviewer HM. In the subpicture SB are displayed, as added information, information directly related to the contents of the main picture MN such as an election news report, emergency news report, weather information, earthquake/tsunami information, or similar, or a picture of information of news which is occurring simultaneously.

When such pictures are viewed in realtime, information displayed in the subpicture SB in FIG. 1 is information which is useful to the viewer. However, when a picture including a main picture MN and a subpicture SB is recorded (video recording), if this picture is viewed at a later time, often the newsworthiness and urgency are lost, and the subpicture SB is unnecessary.

A device has been proposed such that when, as explained above, a telop is displayed within a picture in the main picture, the picture with this telop removed is recorded (see for example Japanese Patent Application Laid-open No. 2011-114750).

However, for pictures in the subpicture, techniques in the past have not enabled detection of the main picture MN from the picture frame PF, and consequently it has not been possible to remove the subpicture SB and record only the main picture MN. Further, when a picture including a main picture MN and subpicture SB is recorded, it is not possible to reproduce only the main picture MN from this recorded picture.

### SUMMARY

A first aspect of a picture detection device includes: an estimation unit configured to, based on deviations in color information of pixels of a prescribed number of lines in an upper-edge portion, lower-edge portion, left-edge portion, and right-edge portion of a picture frame including a first picture and a second picture displayed on the periphery of the first picture, estimate an edge portion of the picture frame in which the second picture is displayed from among the upper-edge portion, the lower-edge portion, the left-edge portion, and the right-edge portion; and a detection unit configured to detect the first picture of the picture flame; wherein the detection unit moves a borderline detection line from the center of the picture frame toward the estimated edge portion, and detects a borderline between the first picture and the second picture based on a brightness difference of pixels in the vicinity of the borderline detection line, and detects the first picture based on the detected borderline.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a picture frame including a main picture, and an L-shape subpicture displayed on the periphery of the main picture;

FIG. 2A to FIG. 2C explain the picture detection device of a first embodiment;

FIG. 3 is a block diagram of an example of a picture detection unit;

FIG. 4A to FIG. 4F explain the shape pattern of a subpicture;

FIG. 5 is an enlarged view of the display pattern illustrated in FIG. 4A;

FIG. 6A and FIG. 6B explain a method of estimating an L-shape boundary;

FIG. 7 is a flow diagram explaining processing to estimate edge portions;

FIG. 8 illustrates an example of a table which is referenced by a control unit when generating shape information for a subpicture;

FIG. 9 is a flow diagram explaining processing to detect a borderline position;

FIG. 10A and FIG. 10B explain processing to detect a borderline position;

FIG. 11 explains erroneous borderline detection;

FIG. 12 explains decision of a borderline position;

FIG. 13A and FIG. 13B explain a picture recording device of a second embodiment;

FIG. 14 is a block diagram of an example of a picture detection unit;

FIG. 15 is a first flow diagram explaining the flow of picture recording processing of a picture recording device;

FIG. 16 is a second flow diagram explaining the flow of picture recording processing of the picture recording device;

FIG. 17 is a third flow diagram explaining the flow of picture recording processing of the picture recording device;

FIG. 18 is a fourth flow diagram explaining the flow of picture recording processing of the picture recording device;

FIG. 19 explains the picture recording device of a third embodiment;

FIG. 20 is a block diagram of an example of a picture detection unit;

FIG. 21 is another first flow diagram explaining the flow of picture recording processing of a picture recording device; and

FIG. 22 is another second flow diagram explaining the flow of picture recording processing of the picture recording device.

### DESCRIPTION OF EMBODIMENTS

### First Embodiment

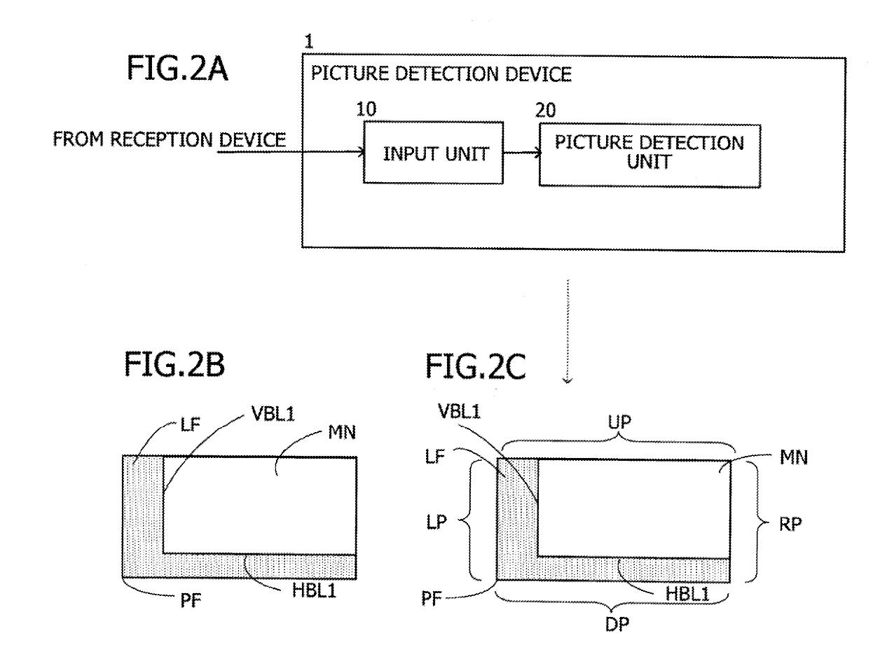

FIG. 2A to FIG. 2C explain a picture detection device 1 of this embodiment.

FIG. 2A is a block diagram of an example of the picture detection device 1.

The input unit 10 of the picture detection device 1 decodes a picture signal received from a broadcasting station or similar by a reception device (not illustrated), and for example inputs the signal to the picture detection unit 2 as a picture frame PF illustrated in FIG. 2B. The picture frame PF is formed from pixels disposed in matrix shape in the row and column directions, and each pixel has color information and a brightness. Color information is for example RGB and color differences. The picture frame PF has for example a main picture MN with a quadrangular shape and an L-shape subpicture SB displayed on the periphery of the main picture MN.

The main picture MN is a first picture, and the subpicture SB is a second picture.

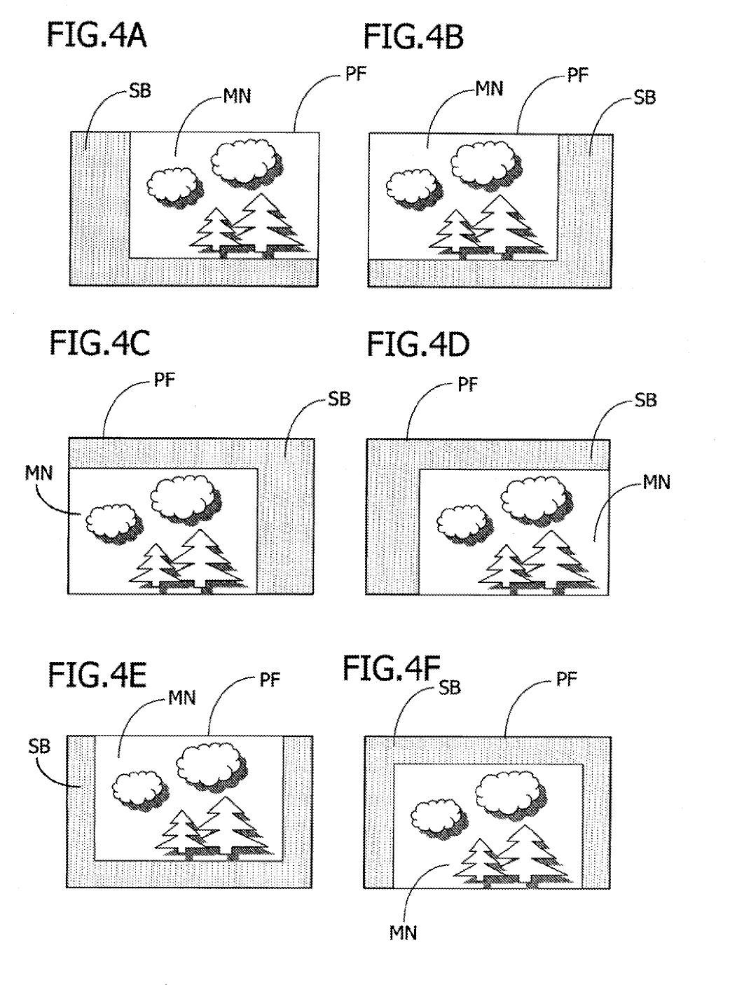

The picture detection unit 20 estimates the edge portions of the picture frame PF in which the subpicture SB is displayed based on deviations in color information of pixels in a prescribed number of lines in the upper-edge portion UP, lower-edge portion DP, left-edge portion LP, and right-edge portion RP of the picture frame PF illustrated in FIG. 2C. The picture detection unit 20 may estimate the edge portions of the picture frame PF in which the subpicture SB is displayed based on deviations in brightness of the pixels in addition to the color information of the pixels in the prescribed number of lines. A specific estimation method is explained using FIG. 4A to FIG. 8.

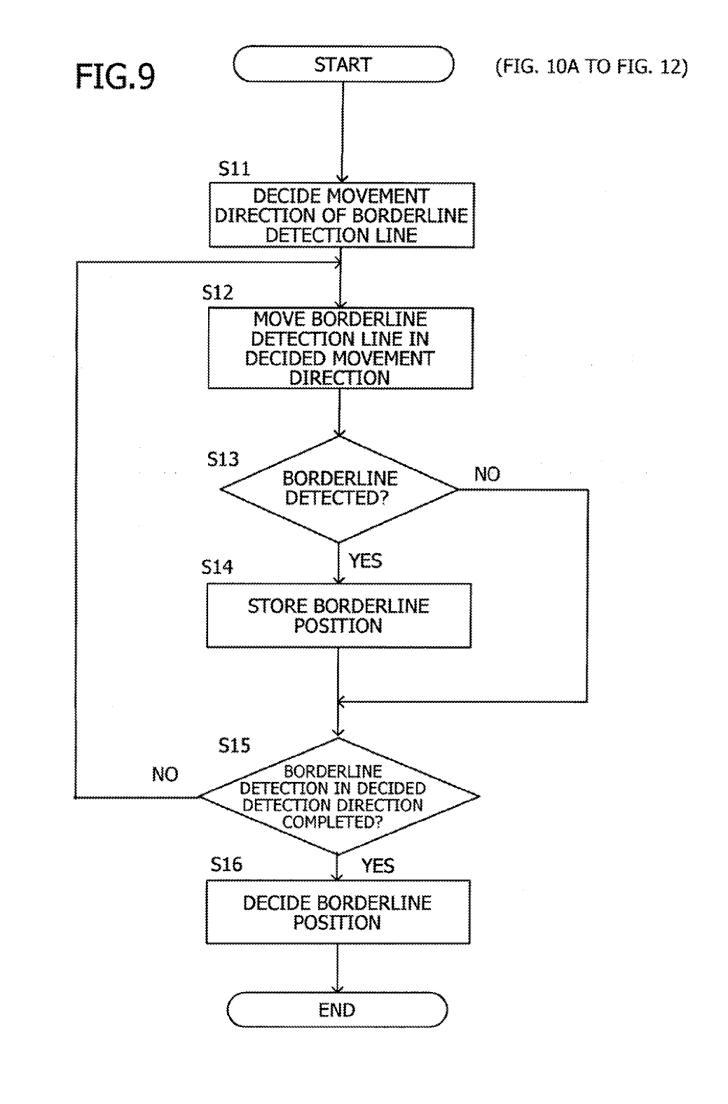

The picture detection unit 20 moves the borderline detection line from the center of the picture frame PF toward the estimated edge portion, and based on brightness differences of pixels in the vicinity of the borderline detection line, detects the borderline between the main picture MN and the subpicture SB, and detects the main picture MN based on the detected borderline. A specific borderline detection method and main picture MN detection method are explained using FIG. 9 to FIG. 12.

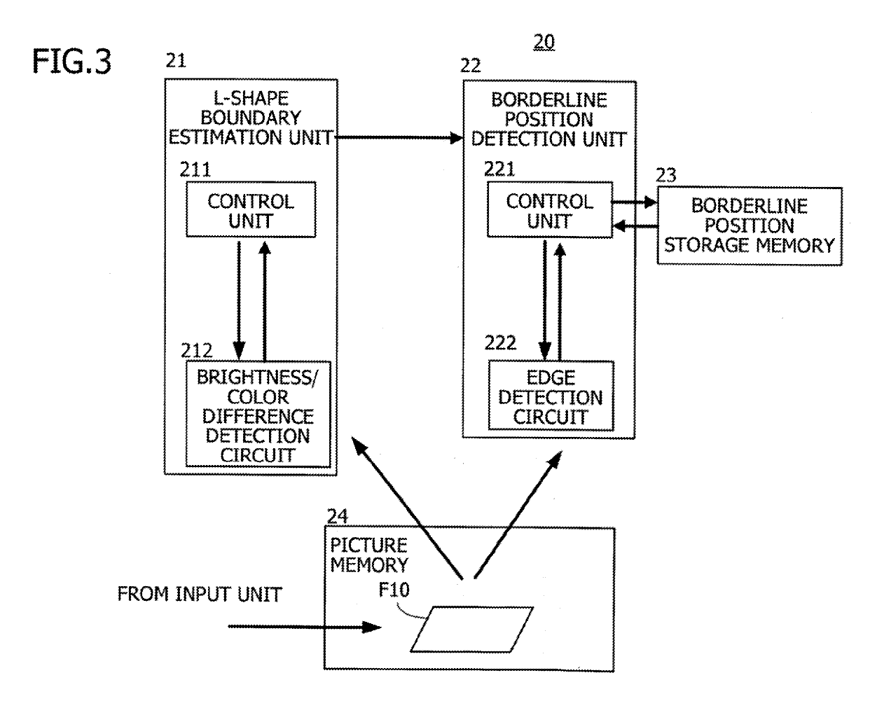

FIG. 3 is a block diagram of an example of the picture detection unit 20.

The L-shape boundary estimation unit 21 has a control unit 211 which controls processing to estimate the edge portions of the picture frame PF in which the subpicture SB is displayed, and a brightness/color difference detection circuit 212 which, based on control by the control unit 211, detects brightness and color differences in pixels within the picture frame PF.

The borderline position detection unit 22 has a control unit 221 which controls processing to detect the borderline between the main picture MN and the subpicture SB, and an edge detection circuit 222 which, based on control by the control unit 221, detects the borderline position. The borderline position detection unit 22 detects the main picture based on the detected borderline position.

The borderline position storage memory 23 is memory which stores borderline positions and similar.

The picture memory 24 is memory which stores picture frames input from the input unit 10.

A picture frame, indicated by the symbol F10, is a picture frame input from the input unit 10, and represents a picture frame for borderline position detection.

Subpicture SB Estimation Processing

Processing to estimate the subpicture SB executed by the L-shape boundary estimation unit 21 is explained, based on FIG. 4A to FIG. 8.

FIG. 4A to FIG. 4F explain shape patterns of subpictures SB. FIG. 4A to FIG. 4F illustrate six shape patterns. In FIG. 4A a subpicture SB is displayed on the lower and left sides of the picture frame PF; in FIG. 4B a subpicture SB is displayed on the lower and right sides of the picture frame PF; and in FIG. 4C a state is illustrated in which a subpicture SB is displayed on the upper and right sides of the picture frame PF. Further, in FIG. 4D a subpicture SB is displayed on the upper and left sides of the picture frame PF; in FIG. 4E a subpicture SB is displayed on the left, right and lower sides of the picture frame PF; and in FIG. 4F a state is illustrated in which a subpicture SB is displayed on the left, right and upper sides of the picture frame PF.

Here, the display pattern of FIG. 4E is a display pattern which combines the display patterns of FIG. 4A and FIG. 4B. Similarly, the display pattern of FIG. 4F is a display pattern which combines the display patterns of FIG. 4C and FIG. 4D, and is also called a U-shape boundary display pattern.

An example of means to estimate whether such an L-shape boundary subpicture SB is being displayed is explained.

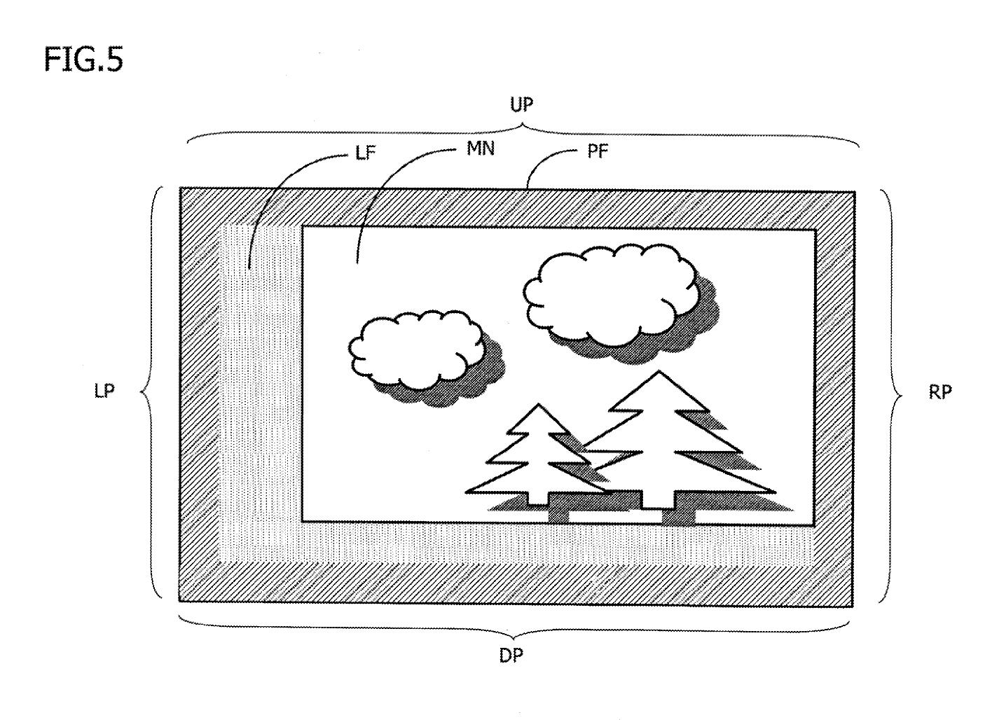

FIG. 5 is an enlarged view of the display pattern illustrated in FIG. 4A. Here, the symbol UP indicates the upper-edge portion of the picture frame PF, and the symbol DP indicates the lower-edge portion of the picture frame PF. Further, the symbol LP indicates the left-edge portion of the picture frame PF, and the symbol RP indicates the right-edge portion of the picture frame PF. In FIG. 5, a prescribed number of lines of each of these edge portions are displayed using oblique hatching. Each of these edge portions is an end portion (outer boundary portion) of the display region of the picture frame PF. Regions displayed with hatching are exaggerated for purposes of explanation.

When a subpicture SB is displayed in a picture frame PF, the pixels of the prescribed number of lines in each of the edge portions do not display character information or similar, and the brightness and color differences of the pixels in these overlapping portions (in other words, the prescribed number of lines in each of the edge portions) are the same or similar. Further, the brightness and color differences of pixels in these overlapping portions do not change with the passage of time.

Hence the brightness and color differences of pixels in the prescribed number of lines in each of these edge portions are detected, and the edge portions of the picture frame PF in which a subpicture SB is displayed are estimated. Hereafter, this estimation processing is called L-shape boundary estimation.

In the following explanation, in order to raise the precision of L-shape boundary estimation, brightness and color differences in the pixels of a prescribed number of lines are detected, and the edge portions of the picture frame PF in which the subpicture SB is displayed are estimated. However, in order to quicken this L-shape boundary estimation processing, only the brightness of the pixels of the prescribed number of lines, or only the color differences of the pixels, may be detected, to estimate the edge portions of the picture frame PF in which the subpicture SB is displayed. Further, instead of using color differences, RGB values may be used to estimate the edge portions of the picture frame PF in which the subpicture SB is displayed.

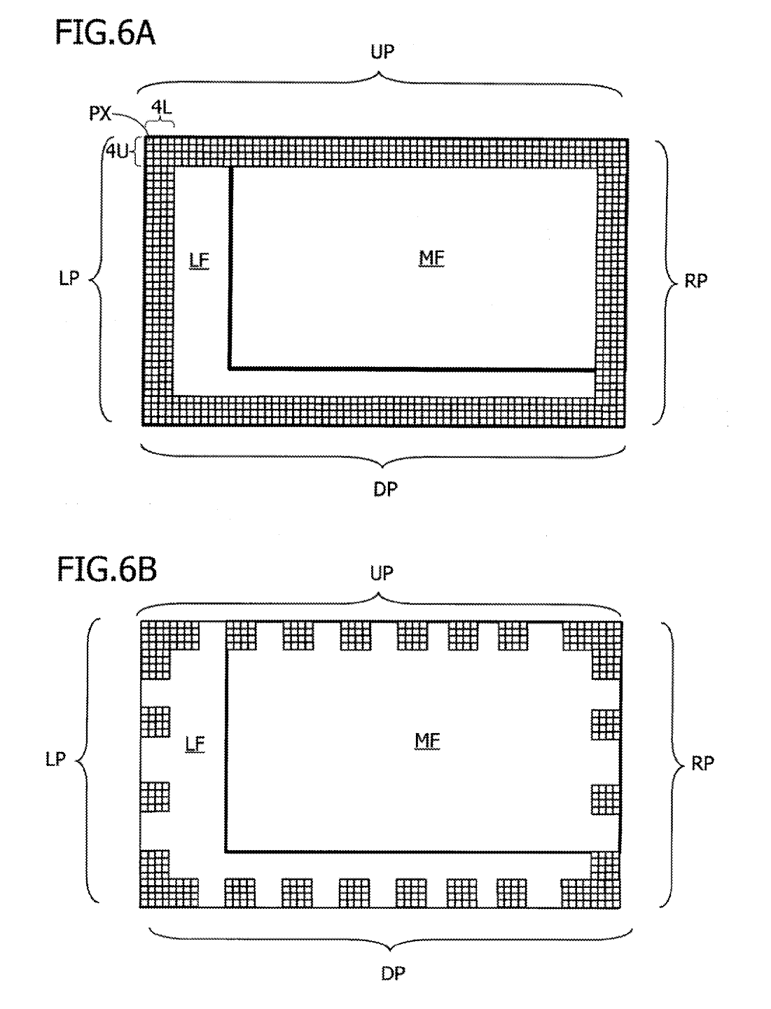

FIG. 6A and FIG. 6B explain methods of L-shape boundary estimation. FIG. 6A explains a first method of L-shape boundary estimate, and FIG. 6B explains a second method of L-shape boundary estimation.

In FIG. 6A, the prescribed numbers of lines of the upper-edge portion UP, lower-edge portion DP, left-edge portion LP, and right-edge portion RP are illustrated using quadrangular pixels.

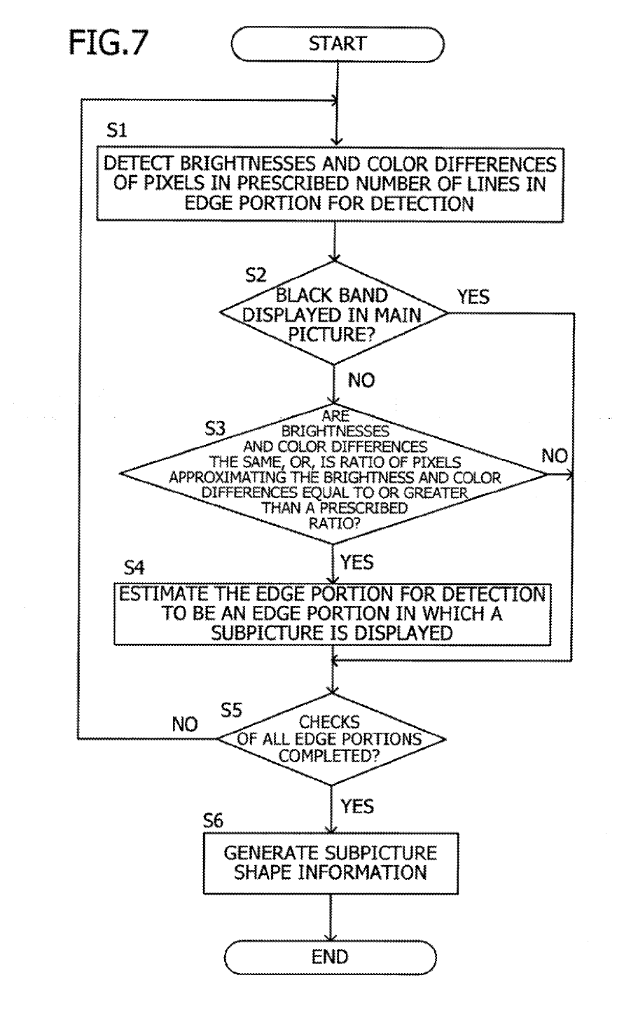

Processing to estimate edge portions is explained based on the flow diagram of FIG. 7. It is assumed that the picture frame F10 has already been read into the picture memory 24. The L-shape boundary estimation unit 21 executes processing of this picture frame F10 to estimate the edge portions in which the subpicture SB is displayed.

Step S1: The control unit 211 of the L-shape boundary estimation unit 21 decides an edge portion for estimation, and the brightness/color difference detection circuit 212 detects brightness and color differences of pixels in the prescribed number of lines of the edge portion decided by the control unit 211.

Processing to decide the edge portion for estimation is explained. First, the control unit 211 decides the prescribed number of lines in the edge portion for estimation. In the cases of the upper-edge portion UP and lower-edge portion DP, the number of lines in the edge portion for estimation is the number of horizontal-direction lines (horizontal lines); in the cases of the left-edge portion LP and right-edge portion RP, the number of lines in the edge portion for estimation is the number of vertical-direction lines (vertical lines). The prescribed number is for example 4 lines.

In this example, four rows of horizontal lines are used in estimation for the upper-edge portion UP and lower-edge portion DP, and four columns of vertical lines are used in estimation for the left-edge portion LP and right-edge portion RP. The horizontal lines for estimation in the upper-edge portion UP are indicated by the symbol 4U, and the vertical lines for estimation in the left-edge portion LP are indicated by the symbol 4L. In FIG. 6A and FIG. 6B, the pixels of these estimation lines are indicated by the symbol PX.

An edge portion for estimation is then decided. Here, for example the upper-edge portion UP is decided as the edge portion for estimation.

The brightness/color difference detection circuit 212 detects the brightness and color differences of all pixels of the lines in the edge portion decided for estimation. For example, the brightness/color difference detection circuit 212 detects the brightness and color differences of all pixels in the lines of the upper-edge portion UP (see symbol 4U), and stores the results in memory (not illustrated).

Step S2: The control unit 211 determines whether a black band is displayed in the main picture.

The reason for executing this determination processing is explained. When the picture frame PF is a standard-quality picture (standard definition video), black bands are displayed in the left-edge portion and the right-edge portion of the main picture. Further, when the picture frame PF is a CinemaScope (a registered trademark) picture, black bands are displayed in the upper-edge portion and the lower-edge portion of the main picture.

When such black bands are displayed in edge portions of a picture frame PF, the control unit 211 erroneously determines that the black band display portion is a portion of a subpicture (L-shape boundary region), so that the accuracy of subpicture estimation is reduced. In order to prevent such erroneous determinations, the determination processing of step S2 is executed.

Specifically, the control unit 211 determines whether the ratio of the detected number of black pixels to the total number of pixels is equal to or greater than a prescribed ratio. Here, a black pixel, in the case of YUV, has a pixel brightness (Y) which is close to the lowest value that can be taken. If the values of brightness that can be taken by a pixel are for example from 0 to 255, then values close to the lowest value are from 0 to 20. Further, pixel color differences (Cr, Cb) are at values close to the intermediate value among values which can be taken. If the color difference values which can be taken by a pixel are from 0 to 255, then these values close to the intermediate value are from 108 to 148. In the case of RGB, each RGB value is a value close to 0. Further, the prescribed ratio is for example 80%.

Here, the control unit 211 reads the brightness and color differences of all the pixels stored in the memory, counts the number of black pixels, and determines whether the ratio of the detected number of black pixels to the number of all the pixels is equal to or greater than the prescribed ratio. When the ratio of the detected number of black pixels to the number of all the pixels is equal to or greater than the prescribed ratio, the control unit 211 determines that a black band is displayed.

When the control unit 211 determines that a black band is not displayed in the main picture (“NO” in step S2), processing proceeds to step S3.

Step S3: The control unit 211 determines whether brightness and color differences are the same for all pixels, or whether the ratio of pixels approximating a certain brightness and certain color differences is equal to or greater than a prescribed ratio.

Specifically, the L-shape boundary estimation unit 21 determines whether the brightness and color differences of all pixels in the prescribed number of lines in the edge portion (for example the upper-edge portion UP) of the picture frame PF are the same. As this method of determination, the L-shape boundary estimation unit 21 may for example check whether the brightness and color differences of the pixels in the prescribed number of lines, stored in memory, are the same.

If not the same, the L-shape boundary estimation unit 21 determines whether, among all the pixels of the prescribed number of lines in the edge portion (for example the upper-edge portion UP) of the picture frame PF, the ratio of the number of pixels approximating the brightness and color differences to the number of all pixels is equal to or greater than a prescribed ratio (a first threshold). Here the prescribed ratio is for example 80%.

As this method of determination, for example if the number of all pixels in the prescribed number of lines stored in memory is TP, and the number of pixels approximating the brightness and color differences among all the pixels in the prescribed number of lines in the edge portion of the picture frame PF is the number of approximating pixels RT, then a method of determination may determine whether the following equation (1) obtains.

RT/TP≧prescribed ratio (1)

Here, a pixel which approximates the brightness and color differences means a pixel having brightness and color differences within a prescribed range of brightness and color differences which serve as references (for example, within the ranges of ±5% of the reference brightness and reference color differences). The brightness and color differences which serve as references are, for example, average values of the brightness and color differences of all the pixels in the prescribed number of lines.

When the brightness and color differences are the same for all the pixels in the prescribed number of lines, that is, when the color information for all pixels is the same, the color information deviation is 0. When, among all the pixels in the prescribed number of lines, the ratio of pixels approximating the brightness and color differences is equal to or greater than the prescribed ratio, the color information deviation is equal to or less than the numeric value corresponding to this prescribed ratio, that is, the deviation is small.

In this way, when the color information deviation is 0 or the color information deviation is small, the edge portion being detected can be estimated to be an edge portion of the picture frame in which a subpicture SB is displayed.

As explained above, when a subpicture SB is displayed in the picture frame PF, the pixels in the prescribed number of lines of the edge portions are the same or approximate a certain brightness and certain color differences, and moreover do not change with the passage of time. Hence in step S1, processing to detect brightness and color differences may be executed for a portion of the pixels rather than for all the pixels in the prescribed number of lines. That is, thinning of the pixels for detection may be performed.

For example, a portion of the pixels in the prescribed number of lines in the upper-edge portion UP and the lower-edge portion DP of a picture frame PF are, for example, 10 pixel blocks (pixel blocks of 4 rows by 4 columns) in the upper-edge portion UP and lower-edge portion UP illustrated in FIG. 6B. Further, a portion of the pixels in the prescribed number of lines in the left-edge portion LP and the right-edge portion RP of the picture frame PF are, for example, 6 pixel blocks (pixel blocks of 4 rows by 4 columns) in the left-edge portion LP and right-edge portion RP illustrated in FIG. 6B.

In this case, in step S3 the L-shape boundary estimation unit 21 determines whether the brightness and color differences of pixels in a portion of the prescribed number of lines in an edge portion of the picture frame PF are the same, or whether the ratio of the number of pixels in the portion which approximate a certain brightness and certain color differences among the portion of pixels in the prescribed number of lines in the edge portion of the picture frame PF is equal to or greater than a prescribed ratio (second threshold).

Returning to the explanation of FIG. 7, when it is determined that the brightness and color differences of all pixels in the prescribed number of lines in the edge portion of the picture frame PF are the same, or that equation (1) is satisfied (“YES” in step S3), processing proceeds to step S4. When the brightness and color differences of all the pixels in the prescribed number of lines in the edge portion of the picture frame PF are not the same, and equation (1) is not satisfied (“NO” in step S3), the processing of step S4 is omitted, and processing proceeds to step S5.

Step S4: The control unit 211 estimates that the detected edge portion (in other words, the edge portion for the detection) is an edge portion of the picture frame in which the subpicture SB is displayed.

Step S5: The control unit 211 determines whether checks of all edge portions have been completed. Specifically, a determination is made as to whether the processing of steps S1 to S4 has been completed from the upper-edge portion UP, lower-edge portion DP, left-edge portion LP, and right-edge portion RP of the picture frame.

When not all of the edge portions have been checked (“NO” in step S5), the control unit 211 returns to step S1 and executes the processing of steps S1 to S4 for a remaining edge portion for which checking has not yet been completed.

That is, the L-shape boundary estimation unit 21 executes the processing of steps S1 to S4 for the upper-edge portion UP, lower-edge portion DP, left-edge portion LP, and right-edge portion RP.

Step S6: The control unit 211 of the L-shape boundary estimation unit 21 generates shape information for the subpicture SB.

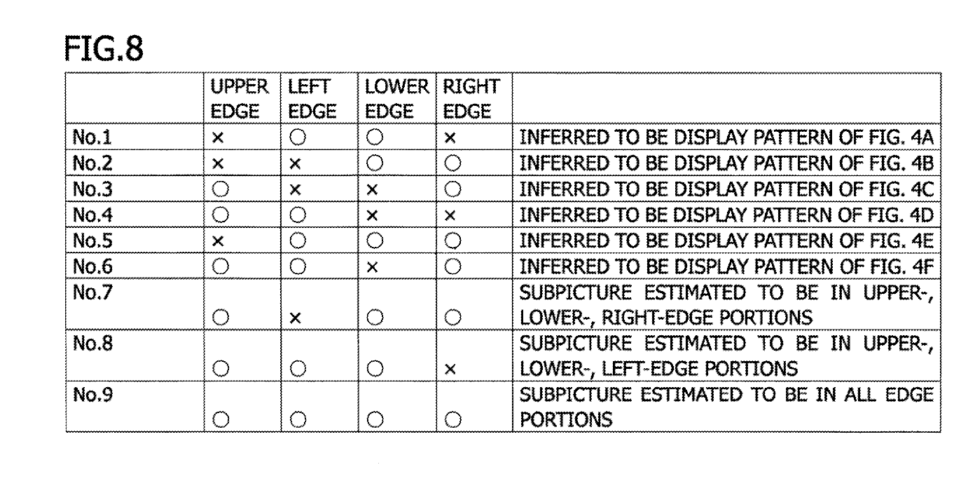

FIG. 8 illustrates an example of a table which the control unit 221 references when generating shape information for the subpicture SB in step S6.

In FIG. 8, identification symbols (No. 1 to No. 9), estimation results for the upper-edge portion, left-edge portion, lower-edge portion, and right-edge portion, and display patterns for subpictures SB based on the estimation results, are recorded. Here the symbol O indicates that in a certain edge portion, the L-shape boundary estimation unit 21 has estimated that the subpicture SB is displayed, and the symbol x indicates that the L-shape boundary estimation unit 21 has estimated that the subpicture SB is not displayed in the edge portion.

When the control unit 211 has estimated that the subpicture SB is displayed in edge portions for which “O” is recorded in the rows identified by the identification symbols No. 1 to No. 9 in FIG. 8, “subpicture present” is generated as shape information of the subpicture SB. For example, as indicated for the identification symbol No. 1, the control unit 211, upon estimating that the subpicture SB is displayed in the left-edge portion and the lower-edge portion (with “O” for the left-edge portion and lower-edge portion, and “x” for the upper-edge portion and right-edge portion), “subpicture present” is generated as shape information for the subpicture SB.

On the other hand, when it is not estimated that a subpicture SB is displayed in an edge portion for which “O” is recorded in FIG. 8, “subpicture not present” is generated as shape information for the subpicture SB. Specifically, this is the case when the control unit 211 estimates that the subpicture SB is displayed only in the upper-edge portion UP and the lower-edge portion DP, or estimates that the subpicture SB is displayed only in the left-edge portion LP and the right-edge portion UP, or estimates that the subpicture SB is displayed only in one edge portion among the upper-edge portion UP, the lower-edge portion DP, the left-edge portion LP, and the right-edge portion RP, or estimates that the subpicture SB is not displayed in any edge portion.

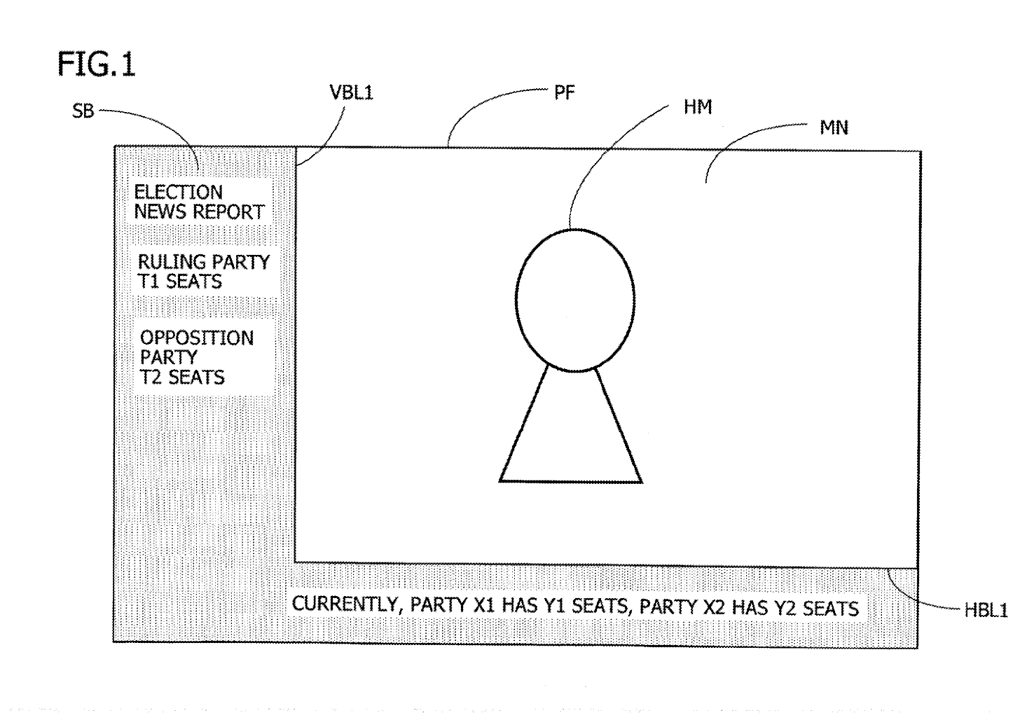

For the picture frame of FIG. 1, consider a case in which the L-shape boundary estimation unit 21 has executed the processing of steps S1 to S5. Suppose that the main picture MN of the picture frame PF in FIG. 1 is the same color outside the interviewer HM. When the L-shape boundary estimation unit 21 executes the processing of steps S1 to S5 for the picture frame PF of FIG. 1, it is estimated that a subpicture SB is displayed in all of the edge portions, upper, lower, left, and right (see identification symbol No. 9). In this case, the control unit 211 generates “subpicture present” as shape information for the subpicture SB.

Borderline Position Detection

Next, the borderline position detection unit 22 checks whether the borderline between the main picture MN and the subpicture SB exists in the peripheral region of the estimated edge portions, and detects the position of this borderline.

When the L-shape boundary estimation unit 21 generates “subpicture present” as shape information for the subpicture SB, the borderline position detection unit 22 detects the position of the borderline between the main picture MN and the subpicture SB. In the example of FIG. 1, the borderline position detection unit 22 detects the positions of the borderline HBL1 in the lower-edge portion DP and of the borderline VBL1 in the left-edge portion LP. When the L-shape boundary estimation unit 21 has generated “subpicture not present” as the shape information of the subpicture SB, it can be estimated that an L-shape subpicture SB is not displayed, and so borderline detection processing is not executed.

Borderline position detection processing is explained based on FIG. 9 to FIG. 11.

FIG. 9 is a flow diagram explaining borderline position detection processing.

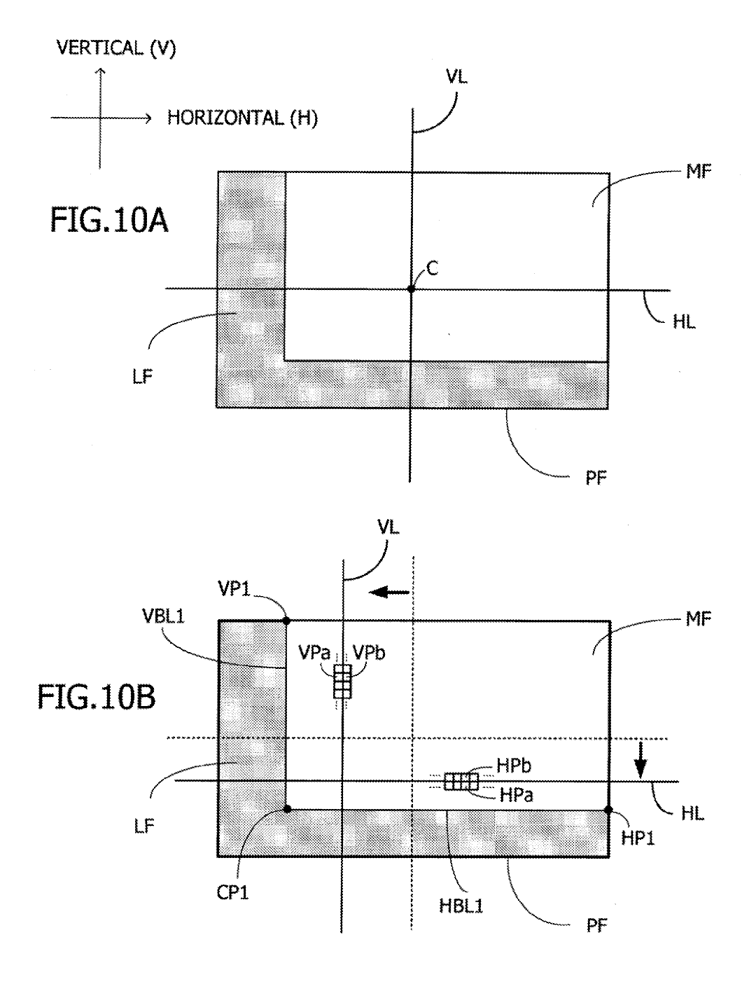

FIG. 10A and FIG. 10B explain borderline position detection processing. FIG. 10A illustrates a vertical borderline detection line VL and a horizontal borderline detection line HL; and FIG. 10B illustrates a state in which the vertical borderline detection line VL and horizontal borderline detection line HL are being slid. FIG. 10A and FIG. 10B correspond to a figure in which, in the picture frame PF of FIG. 1, the interviewer HM and the character information displayed in the subpicture SB are omitted.

Step S11 of FIG. 9: The control unit 221 of the borderline position detection unit 22 decides the directions of movement of the borderline detection lines.

The borderline detection lines are a first vertical borderline detection line VL in the vertical direction, and a second horizontal borderline detection line HL in the horizontal direction. The movement directions of these borderline detection lines are the directions from the center C of the picture frame PF, toward edge portions estimated when the subpicture SB explained in FIG. 7 is displayed.

In the example of FIG. 10A and FIG. 10B, all edge portions are estimated to be edge portions in which the subpicture SB is displayed. Hence the control unit 221 decides the directions of motion for the vertical borderline detection line VL as the left-edge portion LP direction and the right-edge portion RP direction (in the drawing, the leftward and rightward directions), and decides the directions of motion for the horizontal borderline detection line HL as the upper-edge portion UP direction and the lower-edge portion DP direction (in the drawing, the upward and downward directions).

Step S12 in FIG. 9: The edge detection circuit 222 moves the borderline detection lines in the decided movement directions.

That is, the edge detection circuit 222 moves the vertical borderline detection line VL (first borderline detection line, in the vertical direction) in the horizontal direction from the center C of the picture frame PF toward the estimated vertical-direction edge portions. Further, the edge detection circuit 222 moves the horizontal borderline detection line HL (second borderline detection line, in the horizontal direction) in the vertical direction from the center C of the picture frame PF toward the estimated horizontal-direction edge portions. And, the edge detection circuit 222 detects borderlines between the main picture portion MN and the subpicture portion SB based on brightness differences of pixels in the vicinity of the first and second borderline detection lines.

Specifically, the edge detection circuit 222 moves the vertical borderline detection line VL horizontally to the left-edge portion LP and right-edge portion RP, and moves the horizontal borderline detection line HL vertically to the upper-edge portion UP and lower-edge portion DP. As illustrated in FIG. 10B, the edge detection circuit 222 moves the vertical borderline detection line VL horizontally to the left-edge portion LP, and moves the horizontal borderline detection line HL vertically to the lower-edge portion DP.

Various methods can be used as the method of borderline detection. For example, for a vertical-direction borderline, when the difference between the brightnesses of two adjacent pixels VPa and VPb which enclose the vertical borderline detection line VL is equal to or greater than a prescribed threshold, the border between the adjacent pixels VPa and VPb is detected as the vertical-direction borderline. Similarly for a horizontal-direction borderline, when the brightnesses of two adjacent pixels HPa and HPb which enclose the horizontal borderline detection line HL is equal to or greater than a prescribed threshold, the border between the adjacent pixels HPa and HPb is detected as the horizontal-direction borderline.

At this time, it is preferable that, when the difference between the brightness of a prescribed number of pixels in the column direction from the pixel VPa and the brightness of the prescribed number of pixels in the column direction from the pixel VPb is equal to or greater than a prescribed threshold, the border between these adjacent pixels VPa and VPb be detected as the vertical-direction borderline. Here, the prescribed number is for example the number of pixels equal to 80% of all pixels in the column direction. Further, for the difference between the brightness of the pixel VPa and the brightness of the pixel VPb to be equal to or greater than a prescribed threshold means that, for example, the brightness of the pixel VPb is outside the range of ±50% of the brightness of the pixel VPa.

Similarly, it is preferable that, when the difference between the brightness of a prescribed number of pixels in the row direction from the pixel HPa and the brightness of the prescribed number of pixels in the row direction from the pixel HPb is equal to or greater than a prescribed threshold, the border between these adjacent pixels HPa and HPb be detected as the horizontal-direction borderline. Here, the prescribed number is for example the number of pixels equal to 80% of all pixels in the column direction. Further, for the difference between the brightness of the pixel HPa and the brightness of the pixel HPb to be equal to or greater than a prescribed threshold means that, for example, the brightness of the pixel HPb is outside the range of ±50% of the brightness of the pixel HPa.

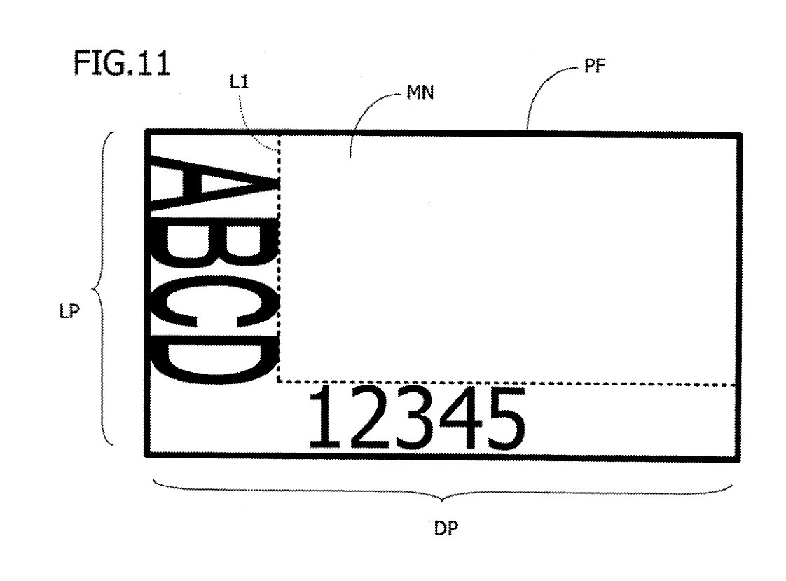

If this prescribed number is made small, then the borderline detection processing ends in a short time, but as explained in FIG. 11, erroneous borderline detection may occur, and thus it is preferable that this value be set appropriately.

FIG. 11 explains erroneous borderline detection. As illustrated in FIG. 11, a case is supposed in which a telop “ABCD” is displayed in the left-edge portion LP and a telop “12345” is displayed in the lower-edge portion DP. In this case also, if borderline detection is performed based on brightness differences between only a portion of the pixels in the column and row directions, the edge detection circuit 222 may erroneously detect the dotted line L1 as a borderline. Hence it is preferable that the above-described prescribed number be appropriately adjusted and set to the optimum value.

In the example of FIG. 10A and FIG. 10B, the edge detection circuit 222 detects the vertical-direction borderline VBL1 and the horizontal-direction borderline HBL1 through the above-described borderline detection processing. When a borderline detection line is moved, movement may be one pixel at a time. In this case, the borderline can be detected with high precision. In addition, the vicinity of the borderline position may be predicted from the aspect ratio of the picture frame PF, with large movement increments of the borderline detection line used until the vicinity of the predicted borderline position vicinity, and before reaching the predicted borderline position vicinity, small movement increments of the borderline detection line may be used. In this case, the borderline detection time is shortened compared with the former method.

The explanation returns to FIG. 9.

Step S13: The control unit 221 of the borderline position detection unit 22 determines whether the edge detection circuit 222 has detected the borderline.

When the borderline has been detected (“YES” in step S13), processing proceeds to step S14.

Step S14: The control unit 221 stores the borderline position detected by the edge detection circuit 222 in borderline position storage memory 23. Here, the stored borderline position is for example information on the coordinates of intersection of the borderline with the picture frame outer boundary. In the example of FIG. 10B, the coordinate VP1 is the information on the coordinates of intersection of the borderline VBL1 in the vertical direction, and the coordinate HP1 is the information on the coordinates of intersection of the borderline HBL1 in the horizontal direction.

When the borderline has not been detected (“NO” in step S13), step S14 is omitted and processing proceeds to step S15.

Step S15: The control unit 221 determines whether borderline detection processing in the decided detection direction has ended. When borderline detection processing in the decided detection direction has not ended (“NO” in step S15), processing returns to step S12. When borderline detection processing in the decided detection direction has ended (“YES” in step S15), processing proceeds to step S16.

Step S16: The control unit 221 decides the borderline position.

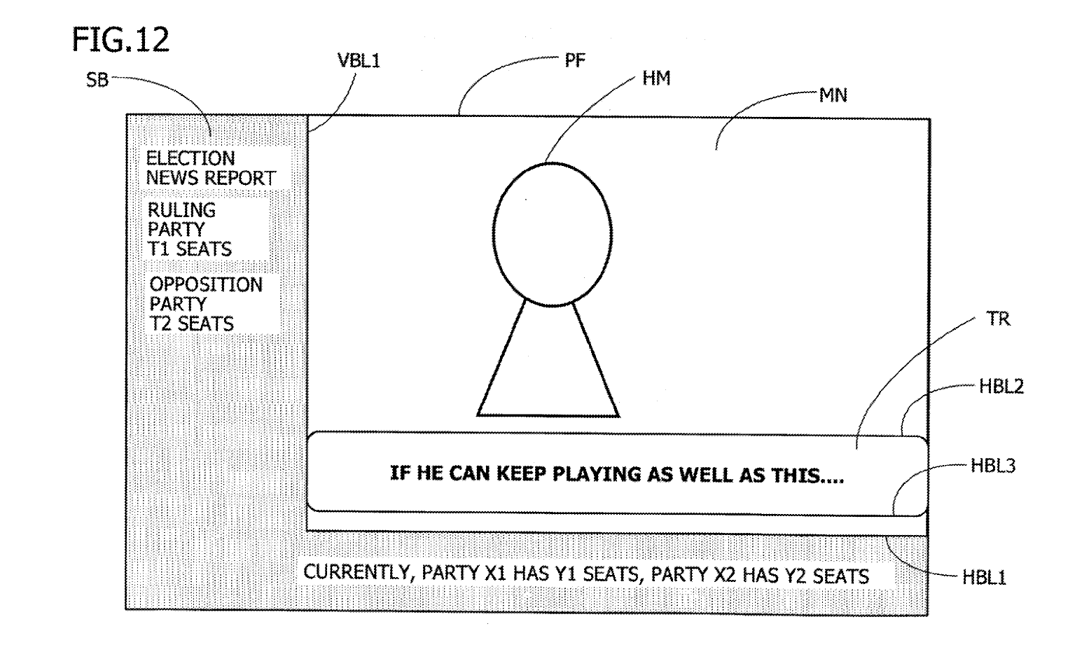

FIG. 12 explains processing to decide the borderline position. FIG. 12 illustrates a state in which, in the display screen of FIG. 1, a telop TR is newly displayed.

When, for the picture frame PF of FIG. 12, the borderline position detection unit 22 executes the processing of steps S11 to S15, the edge detection circuit 222 detects the borderlines HBL1 to HBL4 as horizontal-direction borderlines. In this case, the edge detection circuit 222 must decide which among the borderlines HBL1 to HBL4 is the borderline between the main picture MN and the subpicture SB.

The control unit 221 of the borderline position detection unit 22 detects the aspect ratio of the picture frame PF. The aspect ratio is recorded in the header portion of the picture stream formed from numerous picture frame PFs, or similar.

When the edge detection circuit 222 detects a plurality of horizontal-direction borderlines of the picture frame PF, and detects one vertical-direction borderline, the control unit 221 selects one among a plurality of horizontal -direction borderlines based on the aspect ratio of the picture frame PF, and detects the main picture MN having the aspect ratio.

Based on the example of FIG. 12, the specific processing for borderline decision is explained. First, the borderline position detection unit 22 decides a picture with the same aspect ratio as the aspect ratio of the picture frame PF from among an 11th picture specified by the combination of the vertical borderline VBL1 and the horizontal borderline HBL1, a 12th picture specified by the combination of the vertical borderline VBL1 and the horizontal borderline HBL2, and a 13th picture specified by the combination of the vertical borderline VBL1 and the horizontal borderline HBL3.

In the example of FIG. 12, it is assumed that the 11th picture has the same aspect ratio as the aspect ratio of the picture frame PF. Then, the borderline position detection unit 22 decides (detects) the positions of the borderlines corresponding to this 11th picture (HBL1, VBL1) as the borderline positions, and stores the positions in the borderline position storage memory 23.

Further, when the edge detection circuit 222 of the borderline position detection unit 22 detects a plurality of vertical-direction borderlines and detects a plurality of horizontal-direction borderlines, based on the aspect ratio of the picture frame PF, the control unit 221 selects one among the plurality of vertical-direction borderlines and one among the plurality of horizontal-direction borderlines, and detects the main picture MN having this aspect ratio. In addition, when the edge detection circuit 222 detects a plurality of vertical-direction borderlines and detects one horizontal-direction borderline, based on the aspect ratio of the picture frame PF, the control unit 221 selects one among the plurality of vertical-direction borderlines, and detects the main picture MN having this aspect ratio.

Based on the borderline positions, the control unit 221 of the borderline position detection unit 22 calculates the intersection coordinates of the decided borderline positions (also called the cropping coordinates). In FIG. 10B, the intersection coordinates are the coordinates of VP1, the coordinates of HP1, and the coordinates of the intersection CP1 of the vertical borderline VBL1 and the horizontal borderline HBL1.

Through the above-described processing, the picture detection device 1 can detect the main picture MN bounded by the coordinates of VP1, the coordinates of HP1, and the coordinates of the intersection CP1.

The picture detection device 1 estimates edge portions of the picture frame PF in which the subpicture SB is displayed, moves borderline detection lines from the picture frame center toward the estimated edge portions, and detects borderlines between the main picture MN and the subpicture SB. Hence the main picture MN can be detected with high precision. In addition, even when for example an L-shape subpicture SB is displayed in two areas, borderlines can be detected with high precision and the main picture MN can be detected.

As a result, as is explained in a second embodiment, the main picture alone can be recorded to a recording medium.

### Second Embodiment

A picture recording device 2 having the picture detection device explained in the first embodiment is explained. The picture recording device 2 records only the main picture detected by the picture detection device 1′ to a recording medium 3.

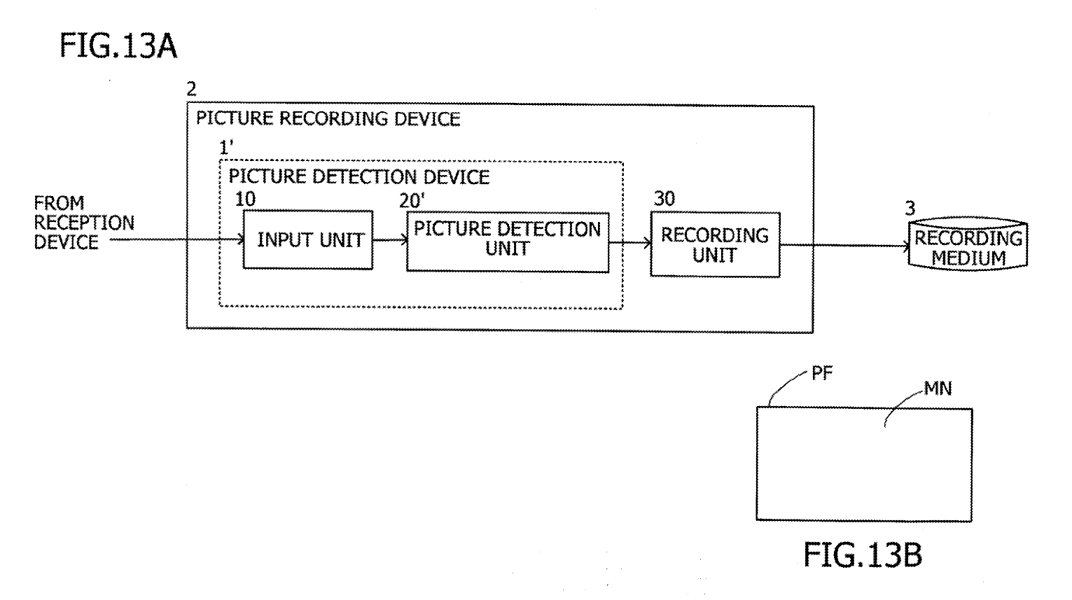

FIG. 13A and FIG. 13B explain the picture recording device 2 of this embodiment. In the following explanation, blocks having the same functions as blocks explained in FIG. 2A to FIG. 2C or FIG. 3 are assigned the same symbols in the explanation.

FIG. 13A is a block diagram of an example of the picture recording device 2.

The picture recording device 2 has the picture detection device 1′, and a recording unit 30 which encodes and records on a recording medium 3 the picture signal of the main picture MN detected by the picture detection device 1′ and similar. As the recording medium 3, for example a hard disk drive may be used, or recording media in various forms can be used.

The picture detection device 1′, after detecting the main picture as explained in the first embodiment, enlarges this main picture to the size of the original picture frame PF. FIG. 13B illustrates this enlarged picture frame.

Then, the recording unit 30 records the picture signal with the enlarged picture frame to the recording medium 3.

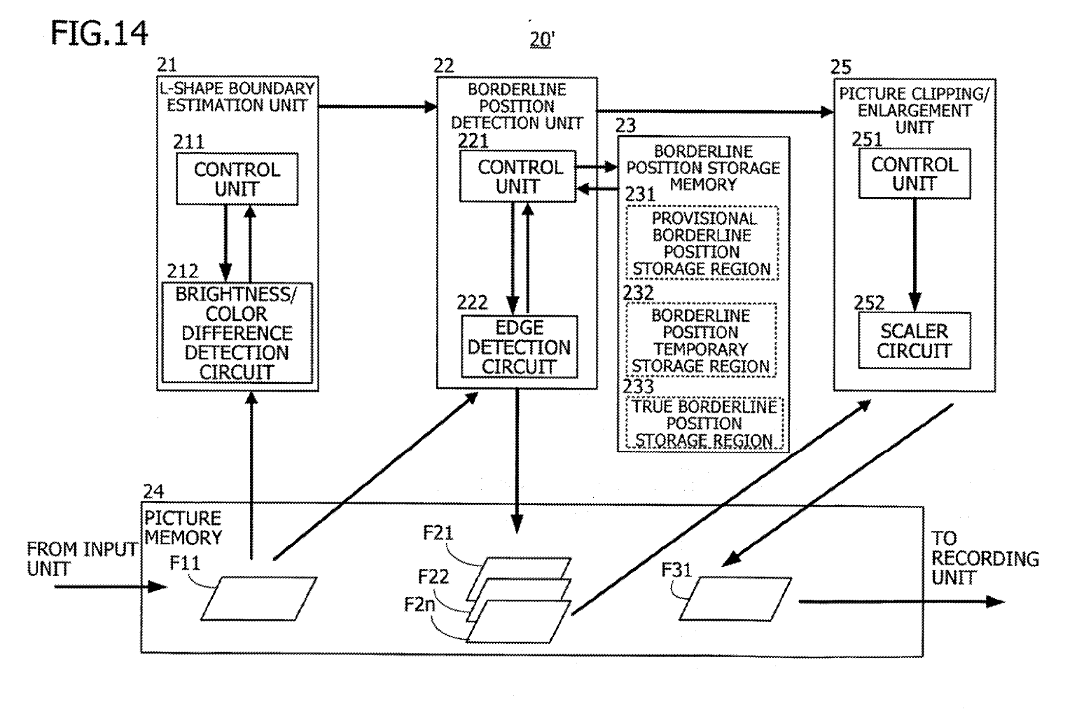

FIG. 14 is a block diagram of an example of the picture detection unit 20′.

The borderline position storage memory 23 is memory which stores borderline positions and similar, and has a provisional borderline position storage region 231, borderline position temporary storage region 232, and true borderline position storage region 233.

A picture clipping/enlargement unit 25 has a control unit 251 which controls processing to clip the picture of a main picture and enlarge the picture to a prescribed size, and a scaler circuit 252 which executes this processing based on control of the control unit 251.

In the picture memory 24, a picture frame, indicated by the symbol F11, is a picture frame input from the input unit 10, and indicates the picture frame before detection of the borderline positions (also called the pre-detection picture frame).

The picture frames indicated by the symbols F21 to F2n are picture frames after borderline detection (also called saved picture frames).

The symbol F31 indicates only picture frame of the main picture.

Explanation of Operation of the Picture Recording Device

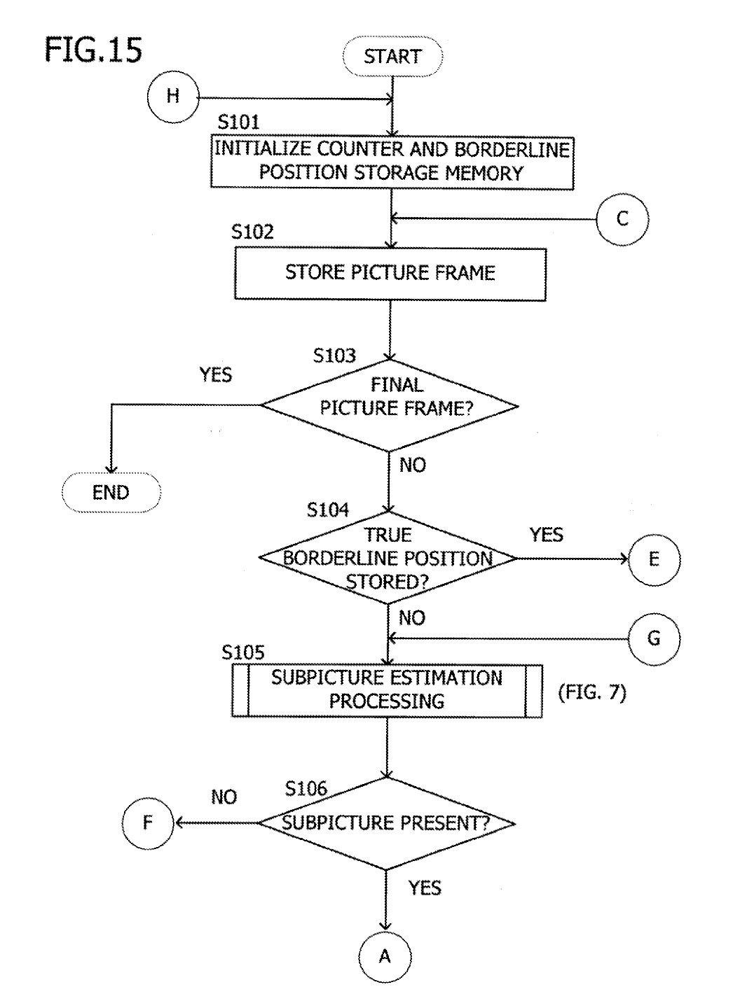

FIG. 15 to FIG. 18 are first to fourth flow diagrams explaining the flow of picture recording processing of the picture recording device 2.

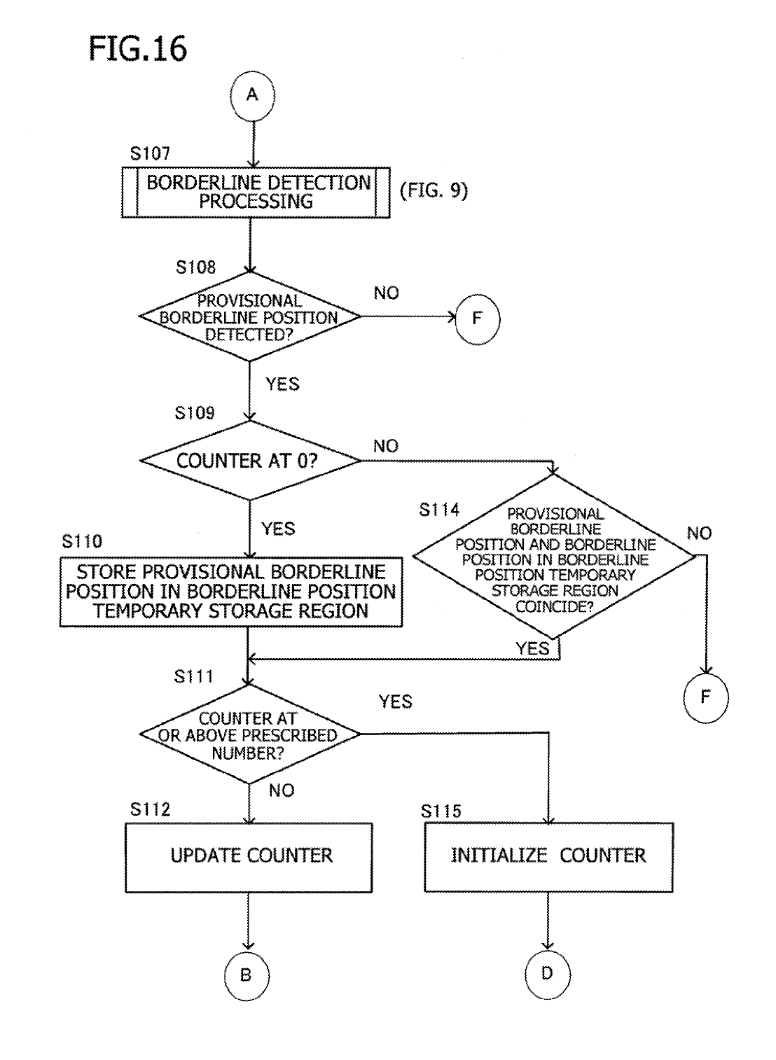

Step S101 in FIG. 15: The picture detection unit 20′ initializes the counter and borderline position storage memory 23. As explained in step S109 of FIG. 16, this counter is referenced when detecting the borderline position between the main picture MN and subpicture SB with high precision. The counter is initialized by setting the counter to 0. The borderline position storage memory 23 is initialized by for example storing NULL in the entire region of the borderline position storage memory 23.

Step S102: The picture detection unit 20′ stores one picture frame input from the input unit 10 in the picture memory 24. This input picture frame is the picture frame indicated by the symbol F11 in FIG. 14.

Step S103: The picture detection unit 20′ determines whether the input picture frame F11 is the final picture frame, that is, determines whether the program for videorecording (also called a picture stream) has ended.

If the input picture frame F11 is not the final picture frame (“NO” in step S103), processing proceeds to step S104. If the input picture frame F11 is the final picture frame (“YES” in step S103), the picture recording device 2 ends picture recording processing.

Step S104: The picture detection unit 20′ determines whether the true borderline positions between the main picture MN and the subpicture SB have been stored in the true borderline position storage region 233. The true borderline position means the borderline position which is finally decided on after the picture detection unit 20′ performs borderline position detection processing for a plurality of picture frames.

If the true borderline positions are not stored in the true borderline position storage region 233 (“NO” in step S104), processing proceeds to step S105. In the above-described explanation, the true borderline positions are not yet stored in the true borderline position storage region 233, and so processing proceeds to step S105.

Step S105: The picture detection unit 20′ executes estimation processing of the subpicture SB. Specifically, the L-shape boundary estimation unit 21 executes each of the steps explained in FIG. 7.

Step S106: The picture detection unit 20′ determines whether the L-shape boundary estimation unit 21 has generated “subpicture present” as shape information for the subpicture SB. Generation of this shape information was explained in step S6 of FIG. 7, and so an explanation is omitted.

When the L-shape boundary estimation unit 21 has generated “subpicture present” as the shape information for the subpicture SB (“YES” in step S106), processing proceeds to step S107 of FIG. 16.

Step S107: The borderline position detection unit 22 executes processing to detect borderline positions between the main picture MN and the subpicture SB. Specifically, the borderline position detection unit 22 executes each of the steps explained in FIG. 9. Here the borderline position detection unit 22 stores borderline positions decided by the processing of step S16 in FIG. 9 in the provisional borderline position storage region 231. A borderline position stored in this provisional borderline position storage region 231 is called a provisional borderline position.

Step S108: The control unit 221 determines whether a borderline position (provisional borderline position) has been detected by the borderline detection processing explained in FIG. 9. When a borderline position has been detected (“YES” in step S108), processing proceeds to step S109.

Step S109: The control unit 221 of the borderline position detection unit 22 determines whether the counter explained in step S101 is at 0.

If the counter is at 0 (“YES” in step S109), for example, if the borderline position detection unit 22 is executing provisional borderline detection processing for the first picture frame, processing proceeds to step S110. For processing up to this point, the counter is at 0, and so processing proceeds to step S110.

Step S110: The control unit 221 stores provisional borderline positions of the provisional borderline position storage region 231 in the borderline position temporary storage region 232.

Step S111: The control unit 221 determines whether the counter is at or above a prescribed number. This prescribed number is explained in the following “True Borderline Position Decision Processing”.

When the counter is not at or above the prescribed number (“NO” in step S111), processing proceeds to step S112. In processing up to this point, the counter is not at or above the prescribed number (“NO” in step S111), and so processing proceeds to step S112.

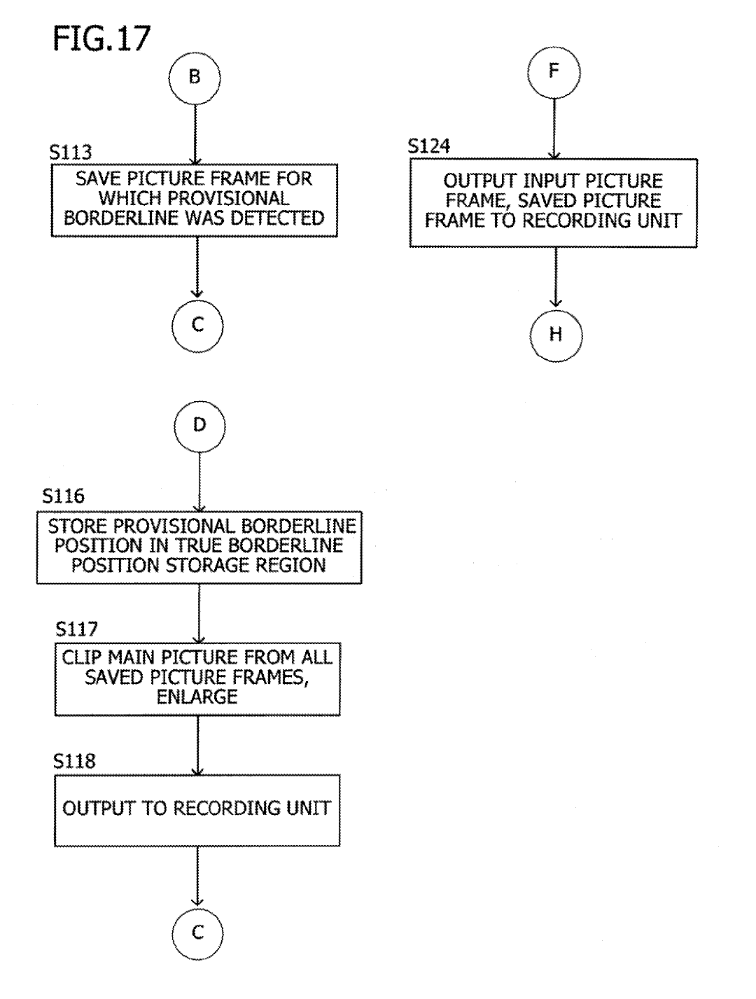

Step S112: The control unit 221 updates the counter. Specifically, the counter is incremented by one. Processing then proceeds to step S113 in FIG. 17.

Step S113: The edge detection circuit 222 saves the picture frame the provisional borderline positions of which have been detected in the picture memory 24. In FIG. 14, the picture frame F11 with provisional borderline positions detected is saved as the picture frame F21.

True Borderline Position Decision Processing

If borderline positions are decided for only one picture frame, the borderline positions are not to be regarded as the correct borderline positions for the main picture MN and subpicture SB. This is because, due to the influence of noise and depending on the type of displayed picture, there is the possibility of erroneous detection of borderlines.

Hence borderline position detection processing is executed for a plurality of picture frames, and when the borderline positions are the same for each of these picture frames, the borderline positions are decided as the correct borderline positions. In the following, such a correct borderline position is called a true borderline position. The number of the plurality of picture frames corresponds to the prescribed number in step S111. This prescribed number can be adjusted.

Below, processing to decide true borderline positions is explained.

After the processing of step S113, processing returns to step S102 in FIG. 15, and the picture detection unit 20′ stores one picture frame input from the input unit 10 in picture memory 24 (step S102 in FIG. 15). This input picture frame is indicated by the symbol F11 in FIG. 14.

Thereafter, the picture detection unit 20′ executes the processing of steps S103 to S109. In the course of this processing, it is assumed that in step S104 of FIG. 15 the result is “NO”, and that in step S108 of FIG. 16 the result is “YES”.

In processing up to this point, the counter is incremented in step S112 of FIG. 16, and thus the counter is not 0 (“NO” in step S109 of FIG. 16), and processing proceeds to step S114.

Step S114: The control unit 221 determines whether the provisional borderline positions stored in the provisional borderline position storage region 231 (provisional borderline positions of the picture frame F11) and the provisional borderline positions stored in the borderline position temporary storage region 232 (provisional borderline positions of the picture frame input from the input unit 10 before this picture frame F11) coincide. If there is coincidence (“YES” in step S114), processing proceeds to step S111.

Here, it is assumed that there is coincidence between the provisional borderline positions stored in the provisional borderline position storage region 231 and the provisional borderline positions stored in the borderline position temporary storage region 232. This coincidence state is a state in which, in the example of FIG. 1, even when there are changes with the passage of time in the picture content of the main picture MN and the character information content of the subpicture SB, there is no change in either the shape of the display region of the main picture MN or the shape of the display region of the subpicture SB.

In step S111, again the control unit 221 determines whether the counter is at or above the prescribed number. Here again, the counter is not yet equal to or greater than the prescribed number (“NO” in step S111), and thus the borderline position detection unit 22 repeats the processing of steps S112, S113, and S102 to S112. In this repetition of processing, it is assumed that the result in step S104 is “NO”, that the result in step S108 is “YES”, and that the result in step S114 is “YES”.

In this repetition of processing, picture frames for which provisional borderline positions are detected are saved in sequence to picture memory 24 (see the symbols F22 to F2n in FIG. 14).

The borderline position detection unit 22 repeats the processing of steps S102 to S112 for the input picture frame, and when the counter becomes equal to or greater than the prescribed number (“YES” in step S111), processing proceeds to step S115.

Step S115: The control unit 221 initializes (sets to 0) the counter, and processing proceeds to step S116 in FIG. 17.

Step S116: The control unit 221 stores the provisional borderline positions stored in the provisional borderline position storage region 231 of the borderline position storage memory 23 in the true borderline position storage region 233. That is, the control unit 221 detects the provisional borderline positions as the true borderline positions. The control unit 221 may store the provisional borderline positions stored in the borderline position temporary storage region 232 in the true borderline position storage region 233. As explained in the first embodiment, these stored true borderline positions are for example information on intersection coordinates between provisional borderlines and the picture frame outer boundary. In the example of FIG. 10B, the information on intersection coordinates for the vertical-direction borderline VBL1 is the coordinates of VP1, and information on intersection coordinates for the horizontal-direction borderline HBL1 is the coordinates of HP1.

Step S117: The picture clipping/enlargement unit 25 clips the main picture MN from all the saved picture frames (symbols F21 to Fn in FIG. 14) and enlarges the picture frames.

Specifically, the control unit 221 of the borderline position detection unit 22 detects cropping coordinates based on the true borderline positions stored in the true borderline position storage region 233 of the borderline position storage memory 23. Then, the control unit 221 outputs the cropping coordinates to the scaler circuit 252. The scaler circuit 252 clips the main pictures MN based on the cropping coordinates, and enlarges the clipped main pictures MN to the same size as the display region of the picture frame PF. The symbol F31 in FIG. 14 indicates the picture frame of this main picture MN alone.

The picture clipping/enlargement unit 25 may also execute calculation of cropping coordinates. In this case, the control unit 221 of the borderline position detection unit 22 outputs the true borderline positions, stored in the true borderline position storage region 233 of the borderline position storage memory 23, to the control unit 251 of the picture clipping/enlargement unit 25.

Step S118: The control unit 251 of the picture clipping/enlargement unit 25 outputs the picture signal for the enlarged main pictures MN to the recording unit 30. The recording unit 30 encodes this picture signal and records the signal to the recording medium 3.

After the end of step S118, processing returns to step S102 of FIG. 15. By executing processing of each of the steps explained above, true borderline positions in picture frames can be detected.

After Detection of True Borderline Positions

After detection of true borderline positions, the main picture MN is decided based on the true borderline positions.

Specifically, after returning to step S102, the picture detection unit 20′ executes the processing explained in steps S102 to S104. In step S102, the picture detection unit 20′ stores a picture frame input from the input unit 10 in picture memory 24 (see symbol F11 in FIG. 14).

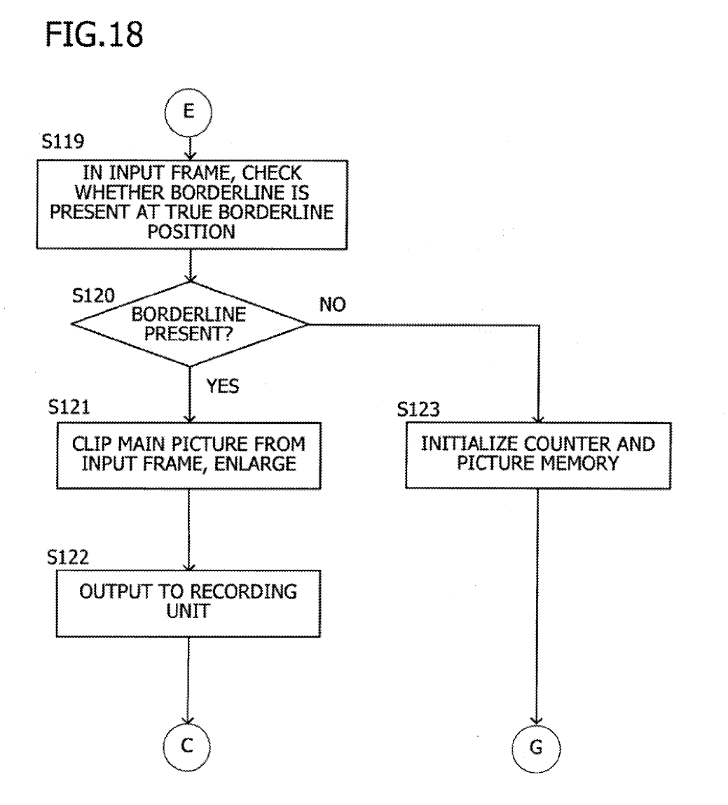

The picture detection unit 20′ already stores true borderline positions between the main picture MN and subpicture SB (see step S116 in FIG. 17), and so the result of step S104 in FIG. 15 is “YES”, and processing proceeds to step S119 in FIG. 18.

Step S119: The control unit 221 of the borderline position detection unit 22 checks whether, in the input picture frame F11, there are borderlines at the true borderline positions.

An example of a method of this checking is explained.

The true borderline positions are coordinates of intersections between borderlines and the picture frame outer boundary. In the example of FIG. 10B, as explained in step S116 of FIG. 17, the coordinates of these intersections are the coordinates of VP1 and the coordinates of HP1.

The edge detection circuit 222 of the borderline position detection unit 22 moves the vertical borderline detection line VL until the true borderline position (coordinates of VP1) in the vertical direction in the input picture frame F11. And as explained in FIG. 9, the edge detection circuit 222 detects the brightnesses of adjacent pixels VPa and VPb enclosing the vertical borderline detection line VL after movement. When the difference in brightnesses of the pixels VPa and VPb is equal to or greater than a prescribed threshold, the control unit 221 determines that a vertical-direction borderline between the main picture MN and the subpicture SB exists at the vertical-direction true borderline position.

Similarly, the edge detection circuit 222 moves the horizontal borderline detection line HL until the true borderline position (coordinates of HP1) in the horizontal-direction. And as explained in FIG. 9, the edge detection circuit 222 detects the brightnesses of the adjacent pixels HPa and HPb enclosing the horizontal borderline detection line HL after movement. When the difference in brightnesses of the pixels HPa and HPb is equal to or greater than a prescribed threshold, the control unit 221 determines that a horizontal-direction borderline between the main picture MN and the subpicture SB exists at the horizontal-direction true borderline position.

When this checking processing ends, processing proceeds to step S120.

Step S120: The control unit 221 of the borderline position detection unit 22 determines whether, in the input picture frame F11, borderlines exist at the true borderline positions.

If, in the input picture frame F11, borderlines exist at the true borderline positions (“YES” in step S120), processing proceeds to step S121.

Step S121: The picture clipping/enlargement unit 25 clips the main picture MN from the input picture frame F11 and enlarges the main picture MN.

Step S122: The control unit 251 of the picture clipping/enlargement unit 25 outputs the enlarged picture frame to the recording unit 30 in FIG. 13A. The recording unit 30 encodes the picture signal of the enlarged picture frame and records the signal to a recording medium 3.

Then, processing returns to step S102 in FIG. 15.

In step S120 of FIG. 18 by the borderline position detection unit 22, when in the input picture frame there is no borderline at a true borderline position (“NO” in step S120), processing proceeds to step S123. That is, when in one videorecorded program the display region shapes of the main picture MN and subpicture SB have changed, processing proceeds to step S123.

Step S123: The borderline position detection unit 22 initializes the counter and picture memory 24, and processing returns to step S105 of FIG. 15. In step S105, subpicture estimation processing is executed.

When the L-shape boundary estimation unit 21 has not generated “subpicture present” as the subpicture SB shape information (“NO” in step S106), processing returns to step S124 in FIG. 17.

In step S108 of FIG. 16, when the borderline position detection unit 22 does not detect a provisional borderline position (“NO” in step S108), processing proceeds to step S124 in FIG. 17.

Further, when in step S114 of FIG. 16 the provisional borderline positions stored in the provisional borderline position storage region 231 and the provisional borderline positions stored in the borderline position temporary storage region 232 do not coincide (“NO” in step S114), processing proceeds to step S124 in FIG. 17.

Step S124: The borderline position detection unit 22 outputs the input picture frame and the saved picture frame to the recording unit 30 in FIG. 13A. The recording unit 30 encodes the picture signals of the input picture frame and the saved picture frame, and records the signals to the recording medium 3. Processing returns to step S101 of FIG. 15, and processing to detect true borderline positions is again executed.

By means of the above processing, the picture recording device 2 records only the main picture MN to the recording medium 3.

By means of the picture recording device 2 of this embodiment, the main picture MN alone can be recorded from a picture frame PF including a main picture MN, and an L-shape subpicture SB displayed on the periphery of the main picture MN. As a result, the viewer can view the main picture MN alone, and convenience is improved.

### Third Embodiment

The picture recording device 2 of the second embodiment recorded only the picture signal of the main picture MN to a recording medium 3. In a third embodiment, a picture recording/reproduction device is explained in which the borderlines between the main picture MN and the subpicture SB, that is, the true borderline positions, are detected at the time of program videorecording, and the borderline positions and picture frames including the main picture MN and subpicture SB are recorded in association. In other words, this picture recording/reproduction device records on a recording medium a picture signal of the picture frame in association with positional information of the detected borderline in the picture frame. This picture recording/reproduction device detects the main picture MN based on the true borderline positions at the time of reproduction of videorecorded pictures including a main picture MN and subpicture SB, and reproduces and displays only this main picture MN.

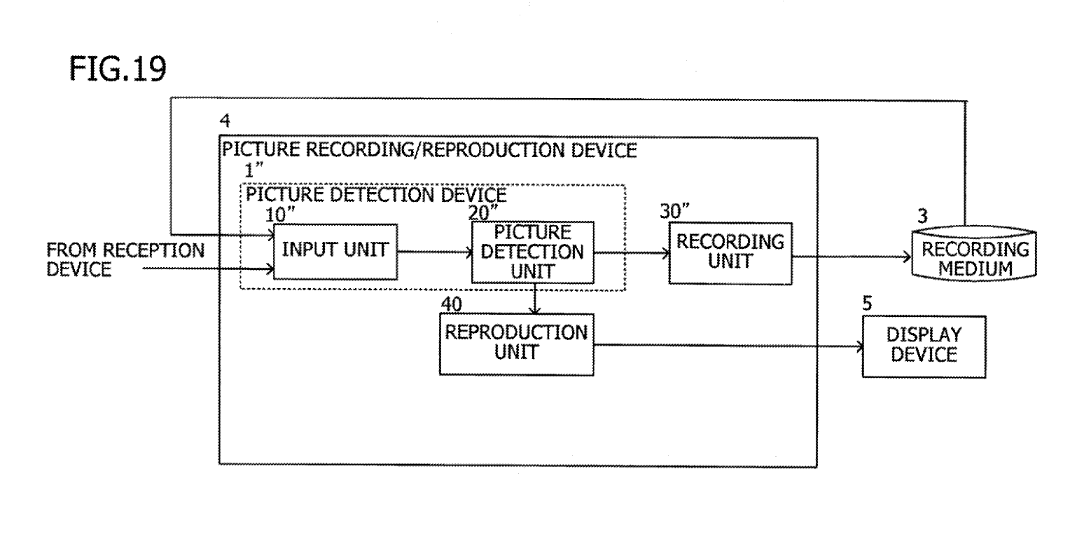

FIG. 19 is a block diagram of an example of the picture recording/reproduction device of the third embodiment.

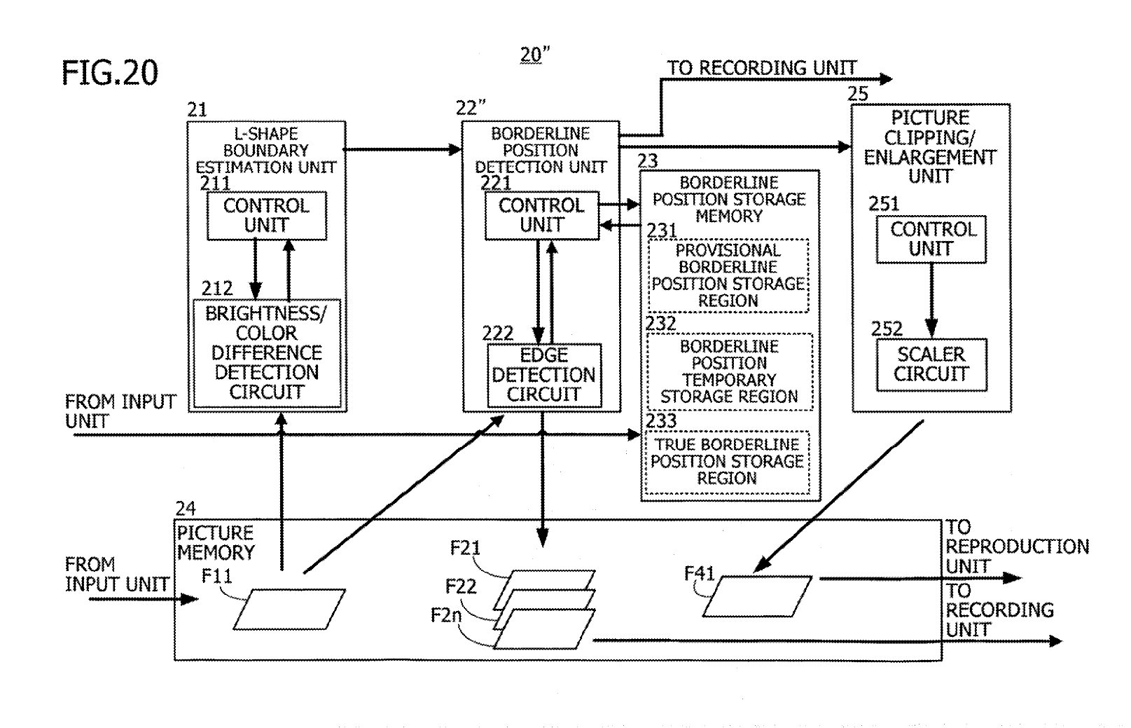

FIG. 20 is a block diagram of an example of the picture detection unit 20″.

The picture recording/reproduction device 4 has, as videorecording modes, a subpicture-excluded videorecording mode and a subpicture non-reproduction mode. The subpicture-excluded videorecording mode is a videorecording mode in which the subpicture SB is excluded and only the main picture MN is recorded, as explained in the second embodiment.

The subpicture non-reproduction mode is a videorecording mode in which, when recording a picture including a main picture MN and a subpicture SB, the true borderline positions are detected, and the true borderline positions are recorded in association with the picture. When reproducing the picture, in this mode only the main picture is reproduced and the subpicture is not reproduced. This videorecording mode can be switched by operation of an operation unit, not illustrated.

The picture recording/reproduction device 4 has a picture detection device 1″, a recording unit 30″, and a reproduction unit 40.

A picture detection unit 20″ of the picture detection device 1″, when in subpicture non-reproduction mode, detects the true borderline positions of the picture frame at the time of recording of a picture including a main picture MN and a subpicture SB.

In addition to the functions explained for the recording unit 30 of FIG. 13A and FIG. 13B, when recording a picture including a main picture MN and a subpicture SB in subpicture non-reproduction mode, the recording unit 30″ records to the recording medium 3 the picture signal of the picture frame PF in association with the true borderline positions in the picture frame PF detected by the picture detection unit 20″.

That is, the recording unit 30″ records to the recording medium 3, as videorecording data, data having a series of picture frames including a main picture MN and a subpicture SB and true borderline positions associated with the picture frames.

In subpicture non-reproduction mode, the input unit 10″ of the picture detection device 1″ reads the videorecorded data recorded to the recording medium 3, and inputs the data to the picture detection unit 20″.

In subpicture non-reproduction mode, the picture detection unit 20″ of the picture detection device 1 detects the main picture MN of the picture frames of videorecorded data input from the input unit 10″. At this time, the picture detection unit 20″ detects the main picture MN of the picture frames based on the true borderline positions recorded in association with the picture frames.

The reproduction unit 40 reproduces and displays, on a display device 5, the picture signal of the main picture MN detected by the picture detection unit 20″.

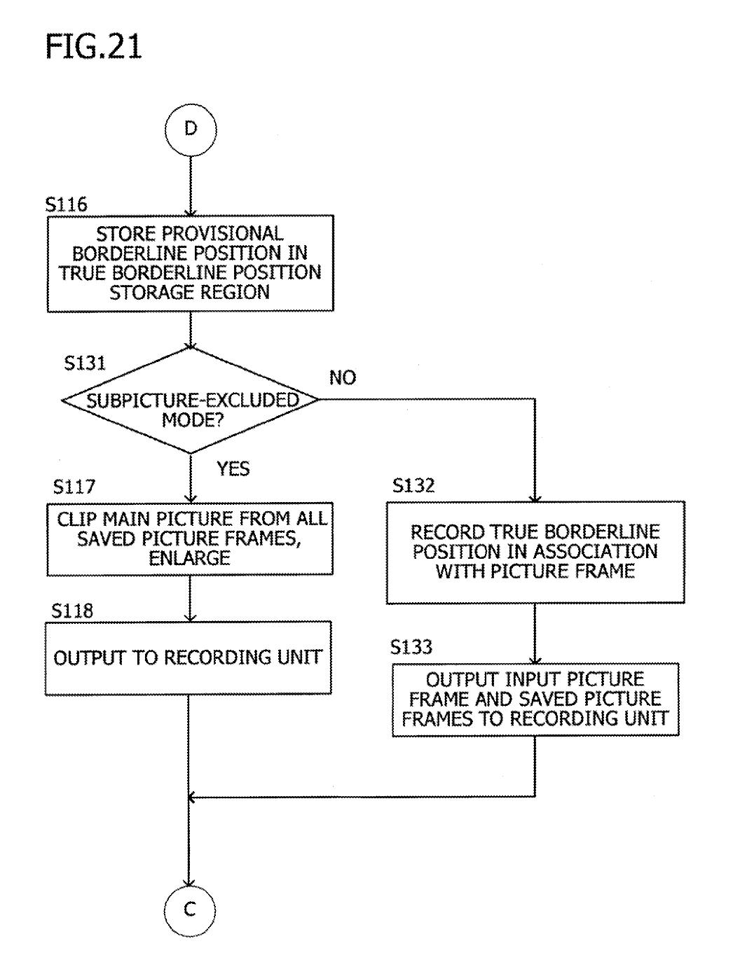

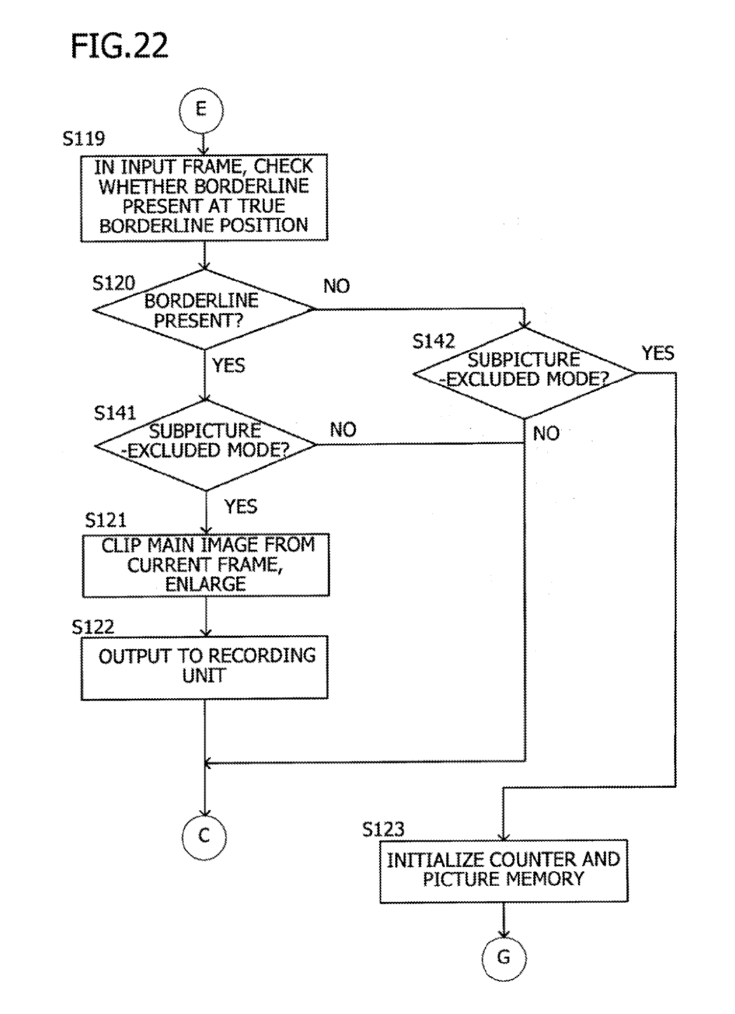

Picture recording processing of the picture recording/reproduction device 4 is explained using FIG. 21 and FIG. 22.

FIG. 21 is a flow diagram which further adds, after step S116 in FIG. 17, the steps S131 to S132. FIG. 22 is a flow diagram which adds, after the step S120 in FIG. 18, the steps S141 and S142.

The picture detection unit 20″ executes the processing explained in FIG. 15 and FIG. 16, and after the processing of step S115 in FIG. 16, processing proceeds to step S116 of FIG. 21. Step S116 is the same processing as step S116 in FIG. 17; the provisional borderline positions stored in the provisional borderline position storage region 231 of the borderline position storage memory 23 are stored in the true borderline position storage region 233. Then, processing proceeds to step S131.

Step S131: The picture detection unit 20″ determines whether the videorecording operation mode is the subpicture-excluded mode. If the videorecording operation mode is the subpicture-excluded mode (“YES” in step S131), processing proceeds to step S117. The processing of step S117 and thereafter was explained in the second embodiment, and so an explanation is omitted. When the operation mode is the subpicture non-reproduction mode (“NO” in step S131), processing proceeds to step S132.

Step S132: The recording unit 30″ records to the recording medium 3 the input picture frames and saved picture frames, in association with the true borderline positions stored in the true borderline position storage region 233.

Specifically, the borderline position detection unit 22″ of the picture detection unit 20″ outputs the true borderline positions, stored in the true borderline position storage region 233, to the recording unit 30. Further, the picture detection unit 20″ outputs the picture frame F11 and picture frames F21 to F2n input to the picture memory 24 to the recording unit 30.

The recording unit 30 records to the recording medium 3 the picture frame F11 and the picture frames F21 to F2n, in association with the true borderline positions. That is, the recording unit 30″ records to the recording medium 3, as videorecording data, data having the picture frame F11 and picture frames F21 to F2n, including a main picture MN and subpicture SB, and the true borderline positions associated with these picture frames.

Then, processing returns to step S102 in FIG. 15.

Next, the picture detection unit 20″ performs the processing of steps S102 in FIGS. 15 to S119 in FIG. 22, and executes the determination processing of step S120 in FIG. 22. In step S120, as explained for step S120 in FIG. 18, whether borderlines are present at true borderline positions in the input picture frame F11 is determined.

In the input picture frame F11, when borderlines are present at the true borderline positions (“YES” in step S120), processing proceeds to step S141.

Step S141: The picture detection unit 20″ determines whether the videorecording operation mode is the subpicture-exclusion mode.

If the videorecording operation mode is the subpicture-exclusion mode (“YES” in step S141), processing proceeds to step S121. If the videorecording operation mode is the subpicture non-reproduction mode (“NO” in step S141), the borderline position detection unit 22″ outputs the input picture frame to the recording unit 30″, and processing proceeds to step S102. The recording unit 30″ records to the recording medium 3 the input picture frame, in association with the true borderline positions stored in the true borderline position storage region 233. The processing of steps S102 and S121 and thereafter were explained in the second embodiment, and an explanation is omitted.

In step S120, when it is determined that a borderline does not exist at a true borderline position in the input picture frame F11 (“NO” in step S120), processing proceeds to step S142.

In step S142, the picture detection unit 20″ executes the same processing as step S141, and in the case of “YES” in step S142, processing proceeds to step S123.

Step S123: The picture detection unit 20″ initializes the counter and borderline position storage memory 23, and processing returns to step S105 in FIG. 15.

In the case of “NO” in step S142, processing proceeds to step S102 in FIG. 15.

By executing the processing explained in FIG. 21 and FIG. 22, the picture recording/reproduction device 4 can record on the recording medium 3 picture signals of picture frames PF in association with true borderline positions in the picture frames PF detected by the picture detection unit 20″.

In one videorecorded program, it may occur that there is a change in the display region shapes of the main picture MN and subpicture SB. That is, the true borderline positions may change. In such a case, the recording unit 30 identifies the picture frame before and after the change by an identifier, time information, or similar. And, a group of picture frames before the change and the true borderline positions of the group of picture frames before the change are recorded in association, and a group of picture frames after the change and the true borderline positions of the group of picture frames after the change are recorded in association.

Next, reproduction processing is explained.

The input unit 10″ reads videorecording data recorded on the recording medium 3, decodes a picture frame, and inputs true borderline positions, recorded in association with the picture frame, to the picture detection unit 20″.

The picture detection unit 20″ stores the picture frame in the picture memory 24. The stored picture frame is the picture frame indicated by the symbol F41 in FIG. 20. The picture detection unit 20″ stores the true borderline positions in the true borderline position storage region 233.

The picture detection unit 20″ calculates the cropping coordinates to clip the main picture MN as explained in the second embodiment, and outputs the results to the control unit 251 of the picture clipping/enlargement unit 25. The scaler circuit 252 clips the main picture MN from the picture frame F41, and executes processing to enlarge the clipped main picture MN to the same size as the display region of the picture frame PF.

The control unit 251 of the picture clipping/enlargement unit 25 outputs the picture signal of the enlarged main picture MN to the reproduction unit 40.

The reproduction unit 40 outputs the picture signal of this main picture MN to the display unit 5, and the signal is reproduced and displayed by the display unit 5.

By means of the picture recording/reproduction device 4 of this embodiment, during reproduction of pictures including a main picture MN and a subpicture SB, it is possible to reproduce only the main picture MN. Further, during videorecording of pictures, the true borderline positions between the main picture MN and subpicture SB are detected and are recorded as videorecording data. Hence when reproducing the pictures, processing to detect true borderline positions is unnecessary, and the main pictures alone can be displayed quickly.

As explained above, by means of the second and third embodiments, a viewer can view only main pictures, and convenience to the viewer can be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A picture detection device, comprising:
an estimation unit configured to, based on deviations in color information of pixels of a prescribed number of lines in an upper-edge portion, lower-edge portion, left-edge portion, and right-edge portion of a picture frame including a first picture and a second picture displayed on the periphery of the first picture, estimate an edge portion of the picture frame in which the second picture is displayed from among the upper-edge portion, the lower-edge portion, the left-edge portion, and the right-edge portion; and
a detection unit configured to detect the first picture of the picture flame;
wherein the detection unit moves a borderline detection line from the center of the picture frame toward the estimated edge portion, and detects a borderline between the first picture and the second picture based on a brightness difference of pixels in the vicinity of the borderline detection line, and detects the first picture based on the detected borderline.

2. The picture detection device according to claim 1, wherein
the pixel color information is a color difference, and
when the color differences of all pixels in a prescribed number of lines in the edge portion of the picture frame are the same, or when the ratio of the number of pixels approximating a color difference among all pixels in a prescribed number of lines in the edge portion of the picture frame to the number of all pixels is equal to or greater than a first threshold, the estimation unit estimates the edge portion of the picture frame to be a edge portion of the picture frame in which the second picture is displayed.

3. The picture detection device according to claim 1, wherein, when the color differences of a portion of pixels in a prescribed number of lines in the edge portion of the picture frame are the same, or when the ratio of the number of pixels approximating a color difference among a portion of pixels in a prescribed number of lines in the edge portion of the picture frame to the number of the portion of pixels is equal to or greater than a second threshold, the estimation unit estimates the edge portion of the picture frame to be a edge portion of the picture frame in which the second picture is displayed.

4. The picture detection device according to claim 1, wherein the detection unit moves a vertical-direction first borderline detection line in a horizontal direction from the center of the picture frame toward the estimated vertical-direction edge portion, and moves a horizontal-direction second borderline detection line in a vertical direction from the center of the picture frame toward the estimated horizontal-direction edge portion, and based on brightness differences of pixels in the vicinities of the first and second borderline detection lines, detects borderlines between the first picture and the second picture.

5. The picture detection device according to claim 4, wherein, when the detection unit detects a plurality of vertical-direction borderlines and also detects a plurality of horizontal-direction borderlines, based on the aspect ratio of the picture frame, the detection unit selects one among the plurality of vertical-direction borderlines and also selects one among the plurality of horizontal-direction borderlines and then detects the first picture having the aspect ratio.

6. The picture detection device according to claim 4, wherein, when the detection unit detects a plurality of vertical-direction borderlines and also detects one horizontal-direction borderline, based on the aspect ratio of the picture frame, the detection unit selects one among the plurality of vertical-direction borderlines and detects the first picture having the aspect ratio.

7. The picture detection device according to claim 4, wherein, when the detection unit detects a plurality of horizontal-direction borderlines and also detects one vertical-direction borderline, based on the aspect ratio of the picture frame, the detection unit selects one among the plurality of horizontal-direction borderlines and detects the first picture having the aspect ratio.

8. A picture recording device, comprising:
an estimation unit, configured to, based on deviations in color information of pixels of a prescribed number of lines in an upper-edge portion, lower-edge portion, left-edge portion, and right-edge portion of a picture frame including a first picture and a second picture displayed on the periphery of the first picture, estimates an edge portion of the picture frame in which the second picture is displayed from among the upper-edge portion, the lower-edge portion, the left-edge portion, and the right-edge portion;
a detection unit configured to detect the first picture of the picture flame; and
a recording unit configured to record on a recording medium a picture signal of the detected first picture;
wherein the detection unit moves a borderline detection line from the center of the picture frame toward the estimated edge portion, and detects a borderline between the first picture and the second picture based on a brightness difference of pixels in the vicinity of the borderline detection line, and detects the first picture based on the detected borderline.

9. A picture recording/reproduction device, comprising:
an estimation unit, configured to, based on deviations in color information of pixels of a prescribed number of lines in an upper-edge portion, lower-edge portion, left-edge portion, and right-edge portion of a picture frame including a first picture and a second picture displayed on the periphery of the first picture, estimates an edge portion of the picture frame in which the second picture is displayed from among the upper-edge portion, the lower-edge portion, the left-edge portion, and the right-edge portion;
a detection unit configured to move a borderline detection line from the center of the picture frame toward the estimated edge portion, detect a borderline between the first picture and the second picture based on a brightness difference of pixels in the vicinity of the borderline detection line, and detect the first picture based on the detected borderline;
a recording unit configured to record on a recording medium a picture signal of the picture frame in association with positional information of the detected borderline in the picture frame; and
a reproduction configured to reproduce the picture signal; wherein
the detection unit configured to detect the first picture in the picture frame recorded on the recording medium, based on the positional information of the borderline recorded in association with the picture signal of the picture frame recorded on the recording medium; and
the reproduction unit configured to reproduce the picture signal of the detected first picture.

10. A picture detection method, comprising:
based on deviations in color information of pixels in a prescribed number of lines in an upper-edge portion, lower-edge portion, left-edge portion and right-edge portion of a picture frame including a first picture and a second picture displayed on the periphery of the first picture, estimating an edge portion of the picture frame in which the second picture is displayed from among the upper-edge portion, the lower-edge portion, the left-edge portion, and the right-edge portion;
moving a borderline detection line from the center of the picture frame toward the estimated edge portion, and based on brightness differences of pixels in the vicinity of the borderline detection line, detecting a borderline between the first picture and the second picture; and
based on the detected borderline, detecting the first picture.

11. A picture recording method, comprising:
based on deviations in color information of pixels in a prescribed number of lines in an upper-edge portion, lower-edge portion, left-edge portion and right-edge portion of a picture frame including a first picture and a second picture displayed on the periphery of the first picture, estimating an edge portion of the picture frame in which the second picture is displayed from among the upper-edge portion, the lower-edge portion, the left-edge portion, and the right-edge portion;
moving a borderline detection line from the center of the picture frame toward the estimated edge portion, and based on brightness differences of pixels in the vicinity of the borderline detection line, detecting a borderline between the first picture and the second picture;
based on the detected borderline, detecting the first picture; and
recording the picture signal of the detected first picture on a recording medium.

12. A picture recording/reproduction method, comprising:
based on deviations in color information of pixels in a prescribed number of lines in an upper-edge portion, lower-edge portion, left-edge portion and right-edge portion of a picture frame including a first picture and a second picture displayed on the periphery of the first picture, estimating an edge portion of the picture frame in which the second picture is displayed from among the upper-edge portion, the lower-edge portion, the left-edge portion, and the right-edge portion;
moving a borderline detection line from the center of the picture frame toward the estimated edge portion, and based on brightness differences of pixels in the vicinity of the borderline detection line, detecting a borderline between the first picture and the second picture;
recording the picture signal of the picture frame in association with positional information of the detected borderline in the picture frame on a recording medium;
based on the positional information of the borderline recorded in association with a picture signal of the picture frame recorded on the recording medium,
detecting a first picture in the picture frame recorded on the recording medium; and
reproducing the picture signal of the detected first picture.
